(19) United States
(12) Patent Application Publication
(10) Pub. No.: US 2016/0311401 A1
(43) Pub. Date: Oct. 27, 2016

(54) Mobile Security System and Integrated Social Security Network

(71) Applicants: Kassim S. Altawil, Burbank, IL (US); Lamya S. Abari, Burbank, IL (US); Akrm K. Altawil, Burbank, IL (US)

(72) Inventors: Kassim S. Altawil, Burbank, IL (US); Lamya S. Abari, Burbank, IL (US); Akrm K. Altawil, Burbank, IL (US)

(21) Appl. No.: 15/092,007

(22) Filed: Apr. 6, 2016

Related U.S. Application Data
(60) Provisional application No. 62/152,649, filed on Apr. 24, 2015.

(51) Int. Cl. B60R 25/30; H04N 7/18; B60R 25/10

(52) U.S. Cl. CPC B60R 25/305; B60R 25/1004; H04N 7/181

(57) ABSTRACT

A mobile security system and integrated social security network for actively monitoring and sharing information about the location and surroundings of a user and a vehicle of the user. A social security application for remotely monitoring the vehicle and communicating with other users is operated on a mobile security unit, a personal security unit, and a personal computing device. The mobile security unit is positioned within the vehicle and is utilized to monitor the vehicle along with a plurality of external cameras and a plurality of sensors peripherally attached to the vehicle. The personal security unit is a portable device carried by the user that can be used to monitor live camera feeds/audio streams from the mobile security unit and the plurality of external cameras, as well as sensor data from the plurality of sensors. Live camera feeds can also be shared between users across the social security network.

The current application claims a priority to the U.S. Provisional Patent application Ser. No. 62/152,649 filed on Apr. 24, 2015.

### FIELD OF THE INVENTION

The present invention relates generally to a system and apparatus for promoting security and social interaction. More specifically, the present invention is a system that uses multiple cameras and sensors to capture and share information about the environment around an individual with a network of authorized parties.

### BACKGROUND OF THE INVENTION

Vehicle theft is a large issue that affects thousands of people each year. While there are some anti-theft devices available to consumers, most are passive systems that only act as a deterrent to vandals. Typical anti-theft devices alert individuals nearby that the vehicle is being tampered with and or make it more difficult to break into or start the vehicle. However, such anti-theft system do not allow a user or another third party to actively surveil a vehicle. By providing 24/7 surveillance of a vehicle, it is much easier to prevent theft or vandalism before such acts occur, as opposed to trying to stop such acts after they have already begun. Ideally, a 24/7 surveillance system would provide both the user and a security surveillance agency with visual monitoring within the vicinity of the vehicle, along with other sensory monitoring. In this way, either the user or the security surveillance agency can immediately notify emergency personnel as a preventative measure. A digital monitoring system operated via a security application would allow a user to monitor a vehicle at the user's convenience and discretion.

Therefore it is the object of the present invention to provide a mobile security system and integrated social security network that allows a user to actively monitor and share information about the location and surroundings of the user and a vehicle of the user. A social security application allows the user to remotely monitor the vehicle on a number of different devices, including a mobile security unit, a personal security unit, a personal computing device, and a navigation system of the vehicle. In addition to remotely monitoring the vehicle, the social security application allows the user to share information and connect with friends through voice char, face chat, and text messaging. The mobile security unit is primarily stationed within the vehicle and provides a plurality of internal video cameras for surveillance. The plurality of internal cameras are used in conjunction with a plurality of external cameras and a plurality of sensors to provide total surveillance of the vehicle. The personal security unit is carried by the user and can be used to remotely view video streams from the plurality of internal cameras and the plurality of external cameras, in addition to providing personal surveillance and security measures. Video streams can also be viewed remotely on the personal computing device. Each of the mobile security unit, the personal security unit, the personal computing device, and the navigation system of the vehicle can be used for communicating with others users via the social security application. Furthermore, the present invention provides a personal health security monitor that is worn by the user. The personal health security monitor measures the vitals of the user and can alert emergency personnel in the event that abnormalities are detected in the vitals. Furthermore, the personal health security monitor includes a global positioning device for gathering location data for the user, wherein the location data is sent to the emergency personnel during an emergency.

### SUMMARY OF THE INVENTION

The present invention is a mobile security system and integrated social security network that allows a user to actively monitor and share information about the location and surroundings of the user and the location and surroundings of a vehicle of the user. Variations of the present invention utilize a mobile security unit, a personal security unit, a personal computing device, and a central control unit that are communicably coupled via a social security application. The present invention can be provided as an aftermarket product, or the present invention can be integrated into a vehicle at the time of manufacture.

For the aftermarket embodiments, the mobile security unit and the personal security device are used and sold exclusively or in tandem. Both the mobile security unit and the personal security unit have universal serial bus (USB) ports for charging, allowing both devices to be used on the go. Additionally, the mobile security unit and/or the personal security unit can be utilized with a wireless earpiece or a personal health security monitor. The mobile security unit is a portable device that can be placed in the vehicle, wherein a plurality of internal cameras monitors the surrounding environment. In one embodiment, the plurality of internal cameras is specifically four cameras; a front camera, rear camera, left side camera, and a right side camera. In another embodiment, the plurality of internal cameras is specifically two cameras; a front camera and a rear camera. Meanwhile, the personal security unit is a portable device that is carried or worn by the user to surveil the surrounding environment of the user, while the personal health security monitor is worn by the user and measures the user's vitals. The wireless earpiece can be utilized to communicate with either the mobile security unit or the personal security unit.

The mobile security unit and the personal security unit can be used standalone or in conjunction with a plurality of external cameras and a plurality of sensors. The plurality of external cameras and the plurality of sensors are mounted to the exterior of the vehicle and are used to monitor the environment surrounding the vehicle. Video and audio feeds from the plurality of external cameras and data from the plurality of sensors can be viewed remotely on the mobile security unit and the personal security unit. The plurality of external cameras and the plurality of sensors can be communicably coupled directly with the mobile security unit and the personal security unit, or the plurality of external cameras and the plurality of sensors can be communicably coupled through a central control unit. The central control unit acts as an information hub, connecting all devices. The central control unit is internally mounted within the vehicle, preferably in a location that is out of sight, such as behind the dashboard.

In the embodiments where the present invention is integrated with the vehicle at the time of manufacture, the central control unit, the plurality of external cameras, and the plurality of sensors are built into the vehicle. The central control unit is connected to the navigation system of the vehicle, a display integrated into the dashboard, or a display below the rear view mirror, wherein the user can interact with the central control unit via the navigation system, dashboard, or rear view mirror display. The plurality of external cameras provides a 360 degree view of the environment around the vehicle, wherein the user can view the camera views through the navigation system, the dashboard display, the rear view mirror display, or the personal security device.

### BRIEF DESCRIPTION OF THE DRAWINGS

FIG. 1 is a front elevational view of the mobile security unit.

FIG. 2 is a rear elevational view of the mobile security unit.

FIG. 3 is an electrical diagram showing the connections between the mobile unit power supply and the mobile unit electronic circuit.

FIG. 4 is a front elevational view of the mobile security unit, wherein the personal security unit is positioned within the docking station.

FIG. 5 is a front elevational view of the personal security unit.

FIG. 6 is an electrical diagram showing the connections between the personal unit power supply and the personal unit electronic circuit.

FIG. 7 is a diagram wherein the central control unit is communicably connecting the other devices of the present invention.

FIG. 8 is an electrical diagram showing the connections between the control power supply and the control unit electronic circuit.

FIG. 9 is an electrical diagram showing the connections between the backup battery and the other devices of the present invention.

FIG. 10 is a diagram showing the plurality of external cameras and the plurality of sensors being peripherally positioned about the vehicle, the digital video recorder and the backup battery positioned in the rear of the vehicle, and the central control unit and the mobile security unit being positioned in the front of the vehicle.

FIG. 11 is a flowchart depicting the security aspects and the social aspects of the social security application.

FIG. 12 is a flowchart thereof, depicting steps for selecting a particular video feed to view.

FIG. 13 is a flowchart thereof, depicting the step for sending the plurality of external data feeds and the plurality of internal data feeds to the third party surveillance center.

FIG. 14 is a flowchart thereof, depicting steps for digitally storing the plurality of external data feeds and the plurality of internal data feeds.

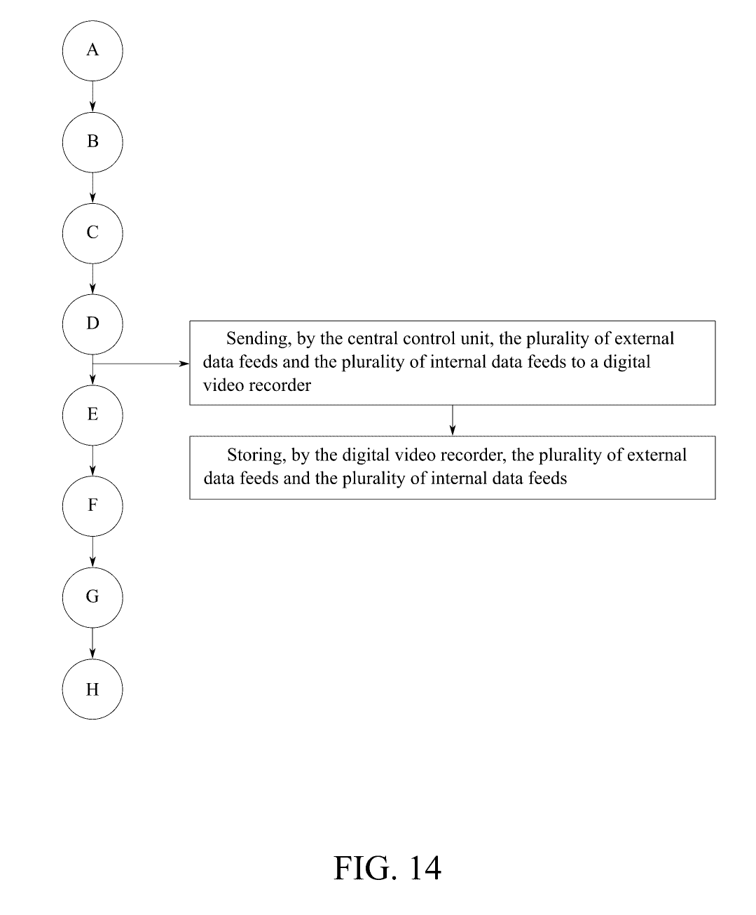

FIG. 15 is a flowchart thereof, depicting steps for turning on the plurality of internal cameras.

FIG. 16 is a flowchart thereof, depicting steps for handling a panic signal initiated by a vehicle panic button.

FIG. 17 is a flowchart thereof, depicting steps for handling a panic signal initiated by a panic button on the personal security unit.

FIG. 18 is a flowchart thereof, depicting steps for handling a panic signal initiated by a personal health security monitor.

FIG. 19 is a flowchart thereof, depicting the communications with the subsequent user device being a live video feed.

FIG. 20 is a flowchart thereof, depicting the step of receiving a voice command through the mobile unit microphone.

FIG. 21 is a flowchart thereof, depicting the step of receiving a voice command through the personal unit microphone.

FIG. 22 is a flowchart thereof, depicting the step of receiving a voice command through the wireless earpiece.

### DETAIL DESCRIPTIONS OF THE INVENTION

All illustrations of the drawings are for the purpose of describing selected versions of the present invention and are not intended to limit the scope of the present invention.

The present invention is a mobile security system and integrated social security network that allows a user to actively monitor and share information about the location and surroundings of the user and the location and surroundings of a vehicle 8 of the user. The mobile security system comprises a central control unit 1, a mobile security unit 2, a personal security unit 3, a wireless earpiece 41, a personal health security monitor 42, a plurality of external cameras 51, a digital video recorder 53, a plurality of sensors 52, and a backup battery 6 that are used in conjunction with each other to monitor the user and the vehicle 8 of the user. A social security application is operated on the mobile security unit 2, the personal security unit 3, and a personal computing device 71 (e.g. a smartphone) of the user, wherein the social security application allows the user to remotely monitor the vehicle 8 and connect to other users in order to share information.

The mobile security system can be integrated into the vehicle 8 at the time the vehicle 8 is manufactured, or the mobile security system can be designed as a retrofit kit installed by the user, car dealer, auto body shop, etc. Additionally, the mobile security system can be adapted for civilian use, law enforcement personnel use, etc. depending on the desired application of the present invention. In embodiments where the mobile security system is designed for law enforcement personnel or similar use, additional security modifications may be necessary in order to satisfy the requirements for national, state, and local law enforcement or emergency response agencies.

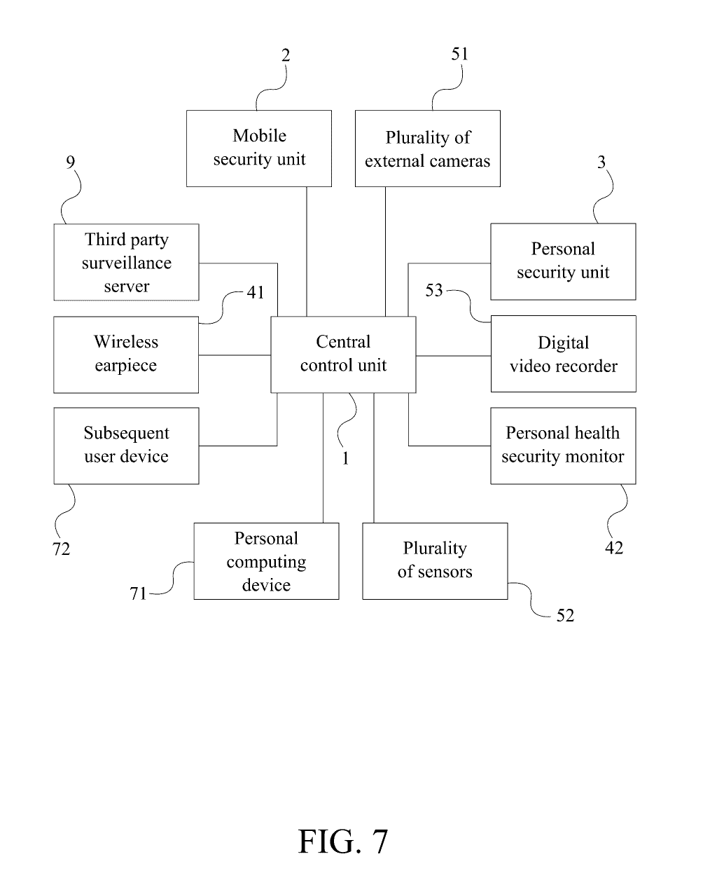

In reference to FIG. 7, the central control unit 1 is the central hub for gathering and sharing information amongst the other components of the mobile security system. As such, the mobile security unit 2, the personal security unit 3, the personal computing device 71, the wireless earpiece 41, the personal health security monitor 42, the plurality of external cameras 51, the digital video recorder 53, and the plurality of sensors 52 are communicably coupled to each other through the central control unit 1. Commands and signals are received and processed by the central control unit 1, wherein the central control unit 1 then executes the corresponding processes. Additionally, the central control unit 1 is communicably coupled with a third party surveillance server 9, such that the central control unit 1 can send video streams, distress signals, or other communications to a security surveillance agency with access to the third party surveillance server 9.

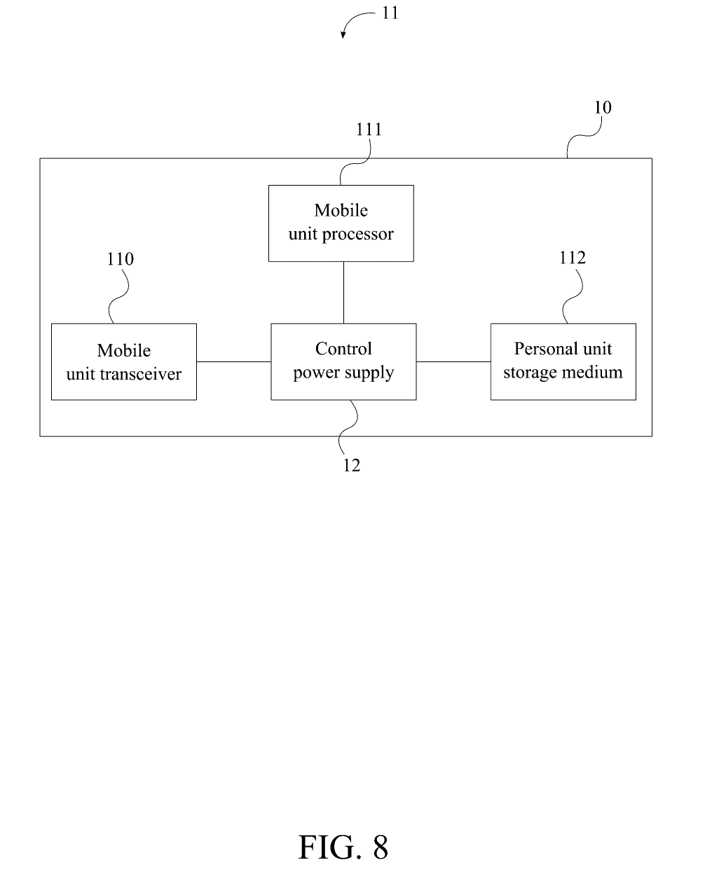

In reference to FIG. 8, the central control unit 1 comprises a control unit housing 10, a control unit electronic circuit 11, and a control power supply 12. The control unit housing 10 provides an enclosure for the control unit electronic circuit 11, wherein the control box is positioned within the vehicle 8, preferably in a discrete location such as behind the dashboard. The control unit electronic circuit 11 comprises the electronic components required to perform the desired actions, including but not limited to, a control unit transceiver 110, a control unit processor 111, and a control unit storage medium 112. The control unit transceiver 110 allows the central control unit 1 to wirelessly communicate with components such as the mobile security unit 2, the personal security unit 3, the personal computing device 71, the personal health security monitor 42, and the wireless earpiece 41. Depending on whether or not the present invention is installed at the time of manufacture or as a retrofit kit, components such as the plurality of external cameras 51, the digital video recorder 53, and the plurality of sensors 52 may be either wirelessly connected to the central control unit 1 or connected via a wired connection.

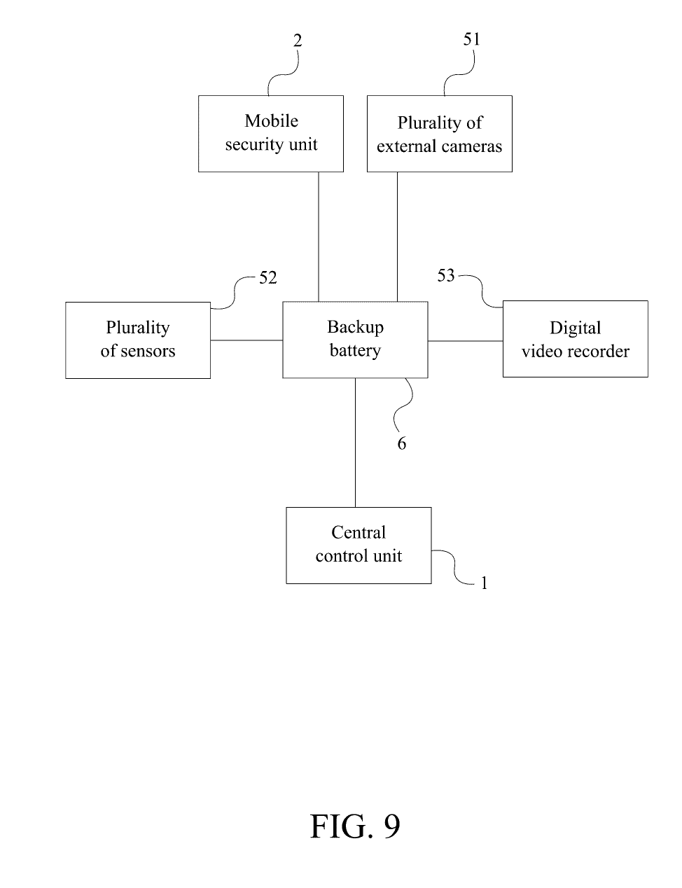

In the preferred embodiment of the present invention, the control power supply 12 is a connector that allows the central control unit 1 to be electrically connected to the battery of the vehicle 8 in addition to the backup battery 6, as depicted in FIG. 9. The control power supply 12 can be positioned within the control unit housing 10, positioned through the control unit housing 10, or positioned external of the control unit housing 10. It is also possible for the control power supply 12 to include an individual battery and the connector for being electrically connected to the backup battery 6. The individual battery is standalone from both the backup battery 6 and the battery of the vehicle 8, and provides electrical current to only the control unit electronic circuit 11 and other components of the central control unit 1. In addition to providing power to the other components of the present invention, the backup battery 6 can also provide power to the vehicle 8, wherein the backup battery 6 is utilized if the battery of the vehicle 8 fails. Preferably, the backup battery 6 is able to provide 72 hours of charge for powering the other components of the present invention and/or the vehicle 8.

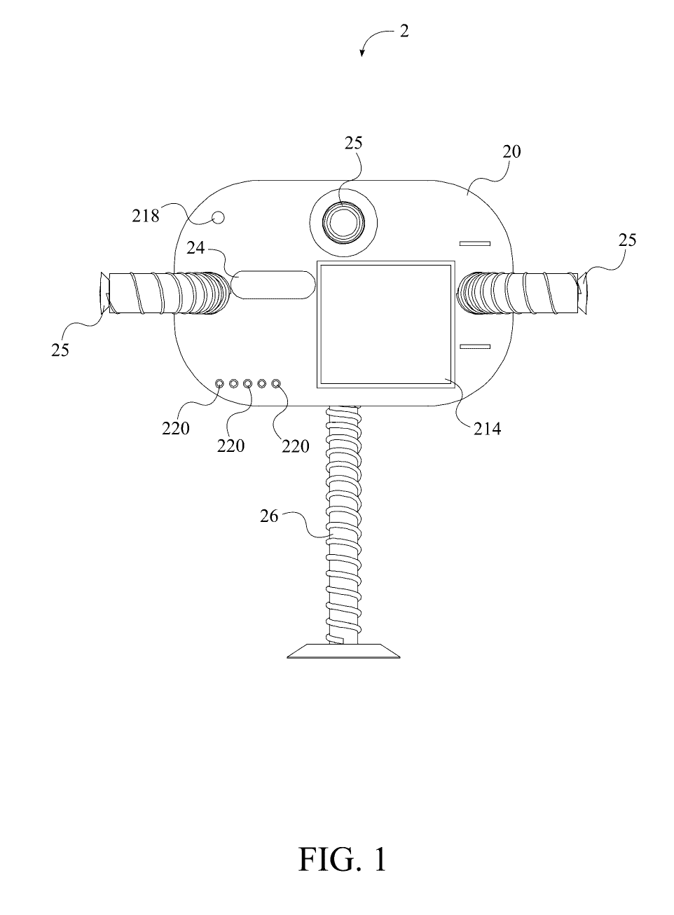

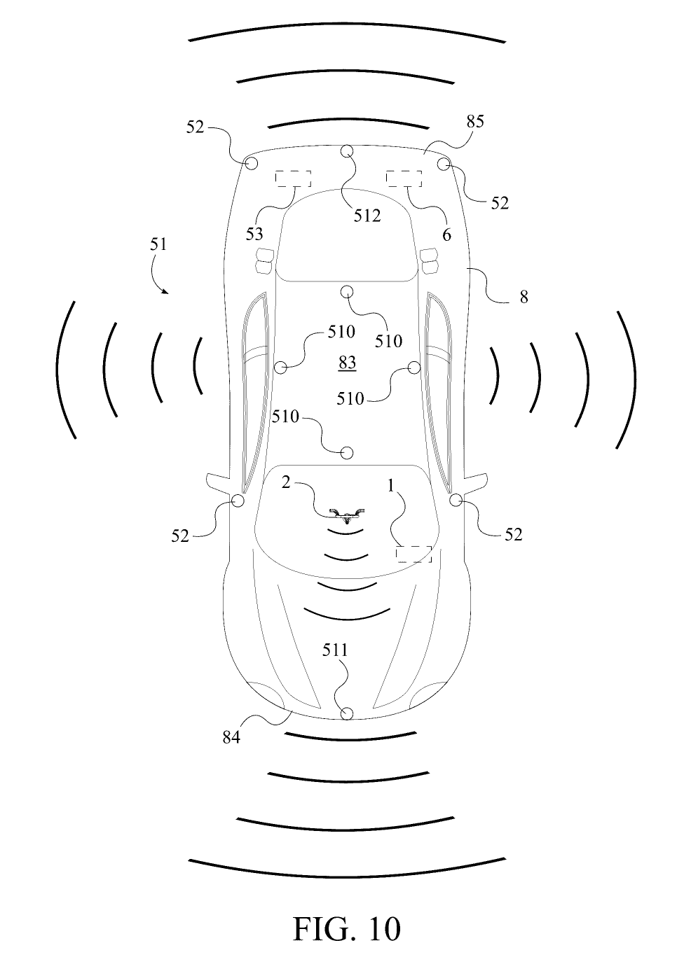

In reference to FIG. 1 and FIG. 10, the mobile security unit 2 is a device that is positioned within the vehicle 8 and is used to monitor the vehicle 8 in addition to providing connectivity to other users via the social security application. Use of the mobile security unit 2 is not limited to the confines of the vehicle 8, however, as the mobile security unit 2 can be removed and used as a standalone device or positioned within a subsequent vehicle 8. The mobile security unit 2 comprises a mobile unit housing 20, a mobile unit electronic circuit 21, a mobile unit power supply 23, a docking station 24, and a plurality of internal cameras 25. The mobile unit housing 20 is a rigid structure that supports the other components of the mobile security unit 2 and is retained in a desirable position relative to the interior of the vehicle 8 by a mobile unit mount 26. In the preferred embodiment of the present invention the mobile unit housing 20 is ergonomically designed to increase aesthetic appeal.

In reference to FIG. 1, as previously stated, the mobile unit mount 26 provides a means for mounting the mobile security unit 2 within the vehicle 8. The mobile unit mount 26 is a connector between the vehicle 8 and the mobile security unit 2 that can be removably attached to the interior of the vehicle 8 or permanently fixed in place. The mobile unit mount 26 is attached to the interior of the vehicle 8, preferably to the dashboard of the vehicle 8, such that the mobile security unit 2 is readily visible and accessible to the user. In the preferred embodiment of the present invention, the mobile unit mount 26 is flexible in order to allow the angle of the mobile security unit 2 to be adjusted in relation to the interior of the vehicle 8.

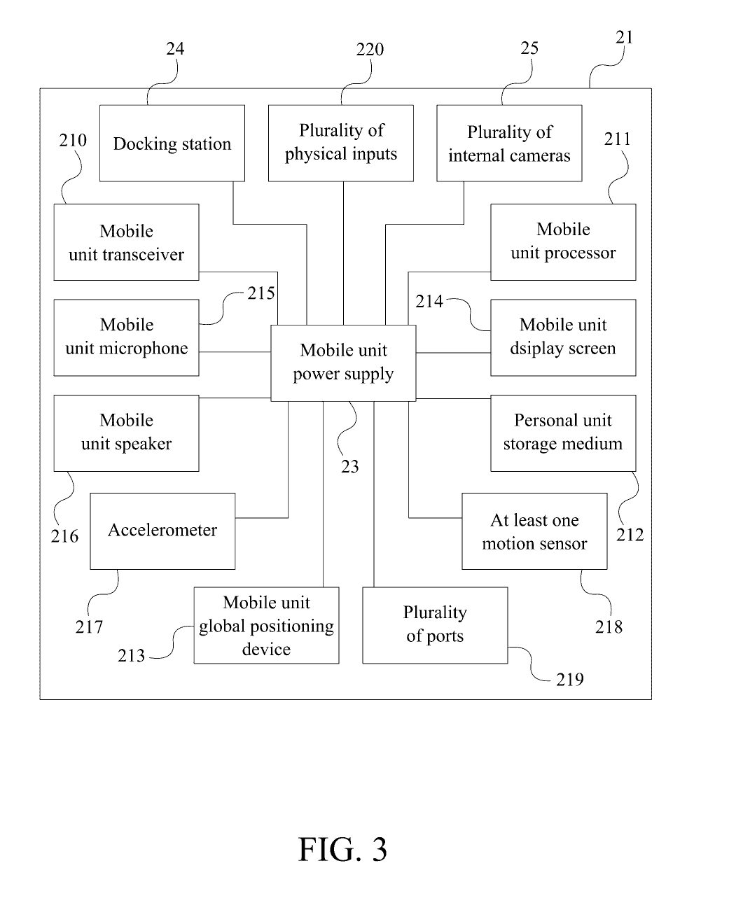

The mobile unit electronic circuit 21 and mobile unit power supply 23 are integrated into the mobile unit housing 20. In reference to FIG. 3, the mobile unit electronic circuit 21 comprises the electronic components required to perform the desired functions of the social security application; more specifically, the mobile unit electronic circuit 21 comprises a mobile unit transceiver 210, a mobile unit processor 211, a mobile unit storage medium 212, a mobile unit global positioning device 213, a mobile unit display screen 214, a mobile unit microphone 215, a mobile unit speaker 216, an accelerometer 217, an at least one motion sensor 218, a plurality of ports 219, and a plurality of physical inputs 220. The mobile unit transceiver 210 allows the mobile security unit 2 to communicate with the central control unit 1, and other devices such as the personal security unit 3, via commonly available wireless standards. The social security application is stored on the mobile unit storage medium 212, while the mobile unit processor 211 processes received signals in order to execute the functions of the social security application.

Each of the plurality of ports 219 provides a means for electrically and/or electronically connecting other devices to the mobile security unit 2. The plurality of ports 219 allows the mobile unit electronic circuit 21 to electronically communicate with other devices, in addition to allowing the mobile security unit 2 provide electrical current to said other devices, or be supplied with current, via the mobile unit power supply 23. In the preferred embodiment of the present invention, the plurality of ports 219 comprises a storage port and a charging port; the storage port allowing a digital storage medium to be connected to the mobile unit electronic circuit 21 and the charging port allowing a power cord to be electrically connected to the mobile unit power supply 23. Preferably the charging port is a universal serial bus (USB) port, however, it is possible for other types of ports to be used for charging. The storage port can be designed to receive any type of digital storage medium, such as Secure Digital (SD) cards, thumb drives, hard drives, and the like.

The mobile unit global positioning device 213 tracks the current location of the mobile security unit 2, wherein location data for the mobile security unit 2 can be shared with the third party surveillance server 9 and other users of the social security application. In the preferred embodiment of the present invention, the mobile unit global positioning device 213 is a Global Positioning System (GPS) receiver that utilizes GPS satellites to retrieve the location data for the mobile security unit 2. Other embodiments of the present invention are designed with alternative positioning systems which can be used to locate the mobile security unit 2. The mobile unit global positioning device 213 is electronically connected with the mobile unit processor 211, wherein the location data is received through the mobile unit global positioning device 213 and subsequently processed by the mobile unit processor 211.

In reference to FIG. 1, the mobile unit display screen 214 is positioned through the mobile unit housing 20 such that the mobile unit display screen 214 is visible to the user. The mobile unit display screen 214 provides a means for presenting a graphical user interface (GUI) of the social security application. The GUI allows the user to interact with the social security application and view information such as other user profiles, message feeds, and video streams sent from other users, in addition to video streams from the plurality of external cameras 51 and the plurality of internal cameras 25. In some embodiments of the present invention, the mobile unit display screen 214 is a touchscreen, wherein the user can navigate through the GUI using touch inputs.

In further reference to FIG. 1, the plurality of physical inputs 220 is integrated into the mobile unit housing 20 and allows the user to interact with the social security application. In the preferred embodiment of the present invention, the plurality of physical inputs 220 includes a power button to turn the mobile security unit 2 off and on, a call button to initiate a call with the personal computing device 71 or the personal security unit 3, a record button to record video streams from the plurality of external cameras 51 and the plurality of internal cameras 25, and a location button to show the current location of the mobile security unit 2. It is possible for any other number of inputs to be provided in other embodiments of the present invention, such as inputs for navigating through the GUI or typing in text. If the mobile unit display screen 214 is a touchscreen, then some or all of the plurality of physical inputs 220 may be provided as icons through the GUI.

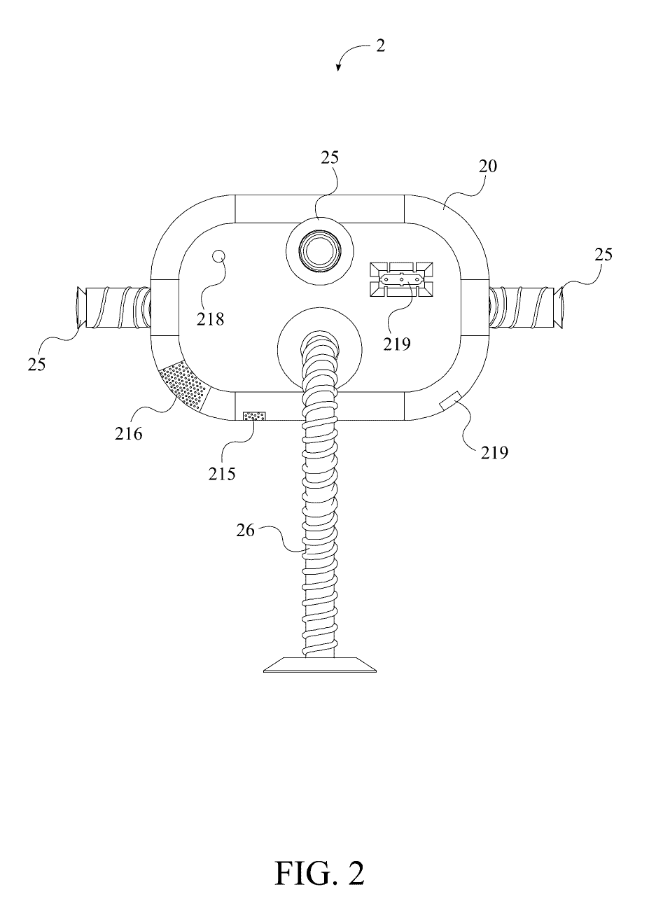

In reference to FIG. 2, the mobile unit microphone 215 and the mobile unit speaker 216 provide an audio input and an audio output, respectively, for the mobile security unit 2. The mobile unit microphone 215 and the mobile unit speaker 216 allow the user to verbally communicate with the social security application and other users. By verbally inputting voice commands through the mobile unit microphone 215, the user can control functions of the social security application and navigate the GUI. Voice commands can include, but are not limited to, a command to send a text message, command to read a text message, command to connect to another user, and command to search a webpage. Additionally, in some embodiments, when the mobile security unit 2 is in a low power or sleep mode, the mobile unit microphone 215 can be used to prompt the mobile security unit 2 to enter a higher power state upon the detection of screams, a cry for help, etc. The mobile unit speaker 216 allows the social security application to verbally communicate back to the user to confirm the execution of a command or relay information to the user. When connected to a second user through the social security application, the mobile unit microphone 215 allows the user to speak to the second user, while the mobile unit speaker 216 allows the user to listen to the second user.

The accelerometer 217 and the at least one motion sensor 218 provide a means for detecting motion of the mobile security unit 2 and movement around the mobile security unit 2, respectively. The accelerometer 217 measures the velocity of the mobile security unit 2, wherein the measured velocity is utilized to allow or disable certain functions of the mobile security unit 2, such as the use of the mobile unit display screen 214. The at least one motion sensor 218 is positioned through a surface of the mobile unit housing 20 and is used to detect the motion of objects around the mobile security unit 2. When the mobile security unit 2 is in a low power or sleep mode, detection of motion by the at least one motion sensor 218 prompts the mobile security unit 2 to enter a higher power state. In the preferred embodiment of the present invention, the at least one motion sensor 218 is specifically a first motion sensor and a second motion sensor, wherein the first motion sensor and the second motion sensor are positioned opposite each other about the mobile unit housing 20 (e.g. the front and back of the mobile unit housing 20), as depicted by FIG. 1 and FIG. 2.

The mobile unit power supply 23 is positioned within the mobile unit housing 20 and provides electrical current to the mobile unit electronic circuit 21, the docking station 24, and the plurality of internal cameras 25. In the preferred embodiment of the present invention, the mobile unit power supply 23 is a rechargeable battery that supplies current to the mobile unit electronic circuit 21 and any devices connected to the mobile security unit 2 through the plurality of ports 219. The mobile unit power supply 23 can be recharged via one of the plurality of ports 219. In other embodiments, the mobile unit power supply 23 may be a connector that allows the mobile security unit 2 to be electrically connected to the battery of the vehicle 8 in addition to the backup battery 6, as depicted in FIG. 9. In such embodiments, the mobile unit mount 26 further comprises a mobile unit charger that is integrated into the mobile unit mount 26 and is electrically connected to the battery of the vehicle 8 and/or the backup battery 6. When the mobile security unit 2 is attached to the mobile unit mount 26, current is supplied to the mobile unit power supply 23 through the mobile unit charger.

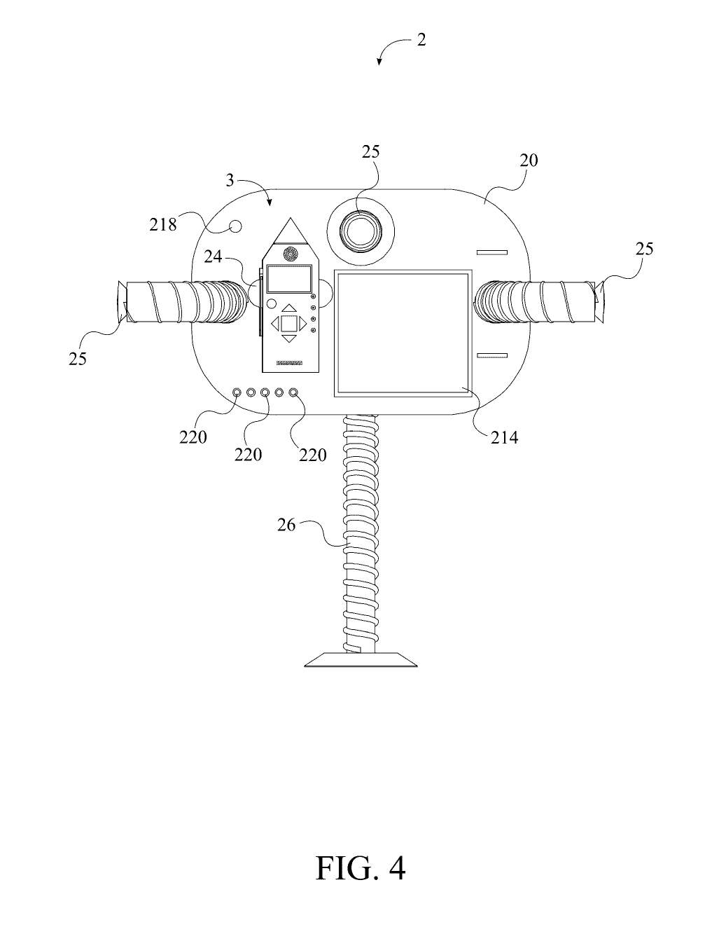

In reference to FIG. 1 and FIG. 4, the docking station 24 provides a means for attaching the personal security unit 3 to the mobile security unit 2. The docking station 24 is a section of the mobile unit housing 20 that enables the user to store and charge the personal security unit 3 while not in use. In the preferred embodiment of the present invention, the docking station 24 is a depression in the surface of the mobile unit housing 20 that is shaped to receive the personal security unit 3. The docking station 24 comprises a personal unit fastener and a charge connection. The personal unit fastener is a fastening member that engages the personal security unit 3 when the personal security unit 3 is positioned within the docking station 24, wherein the personal unit fastener secures the personal security unit 3 within the docking station 24. In some embodiments, the personal unit fastener engages with a mobile unit fastener of the personal security unit 3 to secure the personal security unit 3 in place. The personal unit fastener and the mobile unit fastener can include, but are not limited to, fastening mechanisms such as clips, straps, clasps, snaps, magnets, and hook and loop fasteners. The charge connection provides electrical power from the mobile unit power supply 23 to the personal security unit 3 when the personal security unit 3 is positioned within the docking station 24. To supply power to the personal security unit 3, the charge connection may provide either a physical connection to the personal security unit 3 or a wireless connection using wireless charging technology.

In reference to FIG. 1-2, the plurality of internal cameras 25 is mounted to the mobile unit housing 20, providing a 360 degree view around the mobile security unit 2. Each of the plurality of internal cameras 25 is connected to the mobile unit housing 20 by a camera array connector. The camera array connector is adjacently connected to the mobile unit housing 20 and is a flexible member, wherein the position of each of the plurality of internal cameras 25 can be adjusted by manipulating the camera array connector for a particular internal camera from the plurality of internal cameras 25. Each of the plurality of internal cameras 25 is electrically connected to the mobile unit power supply 23 and electronically connected to the mobile unit electronic circuit 21 through the camera array connector. In other embodiments of the present invention, each of the plurality of internal cameras 25 may be wirelessly connected to the mobile unit electronic circuit 21. Additionally, in some embodiments, when the mobile security unit 2 is in a low power or sleep mode, the plurality of internal cameras 25 can be used to prompt the mobile security unit 2 to enter a higher power state upon the detection of a dangerous situation such as a fight.

Furthermore, each of the plurality of internal cameras 25 is equipped with night vision capabilities, thus allowing the mobile security unit 2 to be used at all hours of the day. The night vision capabilities of the plurality of internal cameras 25 may be activated automatically using sensors or a timer, or the night vision capabilities can be activated manually by the user. Additionally, as the mobile security unit 2 can be removed from the vehicle 8, each of the plurality of internal cameras 25 is also waterproof to protect the plurality of internal cameras 25 from the elements. In some embodiments of the present invention, each of the plurality of internal cameras 25 may also comprise a camera microphone, a camera light, and a camera global positioning device. The camera microphone allows each of the plurality of internal cameras 25 to record audio of the surrounding environment to further monitor the area surrounding the mobile security unit 2. The camera light can be used as a spotlight or to otherwise illuminate a targeted location. Preferably, the camera light is a light emitting diode(s) (LED), however, it is possible for other light sources to be used. The camera global positioning device of each of the plurality of internal cameras 25 tracks the location of the plurality of internal cameras 25 in the event one of the plurality of internal cameras is lost or stolen.

In reference to FIG. 10, the plurality of external cameras 51 is mounted to the exterior of the vehicle 8 and positioned to provide a complete view of the environment around the vehicle 8. Each of the plurality of external cameras 51 is attached to the vehicle 8 by a camera array mount. The camera array mount for each of the plurality of external cameras 51 may retain the plurality of external cameras 51 in a fixed position, or allow the plurality of external cameras 51 to be repositioned to achieve the desired viewing angle. Each of the plurality of external cameras 51 is communicably coupled to the central control unit 1, either via a wireless or wired connection, such that the video streams of the plurality of external cameras 51 are relayed directly to the central control unit 1. In the preferred embodiment of the present invention, each of the plurality of external cameras 51 is electrically connected to the battery of the vehicle 8 and the backup battery 6, as depicted in FIG. 9, however, it is also possible for the plurality of external cameras 51 to be powered by a separate power source.

In further reference to FIG. 10, in order to provide a 360 degree view around the vehicle 8, the plurality of external cameras 51 includes several cameras that are specifically positioned about the vehicle 8. In the preferred embodiment of the present invention, the plurality of external cameras 51 comprises an at least one front bumper 84 camera 511, an at least one rear bumper 85 camera 512, and an at least one rooftop camera 510 being attached to a front bumper 84 of the vehicle 8, a rear bumper 85 of the vehicle 8, and a roof 83 of the vehicle 8, respectively. The at least one front bumper camera 511 and the at least one rear bumper camera 512 allow the user to view license plates and the ground below cars, while the at least one rooftop camera 510 provides a heightened view of the area around the vehicle 8. It is possible for additional external cameras to be utilized in other embodiments of the present invention, such as door cameras, side panel cameras, undercarriage cameras, etc.

Similar to the plurality of internal cameras 25, each of the plurality of external cameras 51 is equipped with night vision capabilities, thus allowing the mobile security unit 2 to be used at all hours of the day. The night vision capabilities of the plurality of external cameras 51 may be activated automatically using sensors or a timer, or the night vision capabilities can be activated manually by the user. Additionally, as each of the plurality of external cameras 51 is mounted externally on the vehicle 8, or otherwise exposed to the elements, each of the plurality of external cameras 51 is also waterproof to protect the plurality of external cameras 51 from the elements. In some embodiments of the present invention, each of the plurality of external cameras 51 may also comprise a camera microphone, a camera light, and a camera global positioning device. The camera microphone allows each of the plurality of external cameras 51 to record audio of the surrounding environment to further monitor the vehicle 8. The camera light can be used as a spotlight or to otherwise illuminate a targeted location. Preferably, the camera light is a LED(s), however, it is possible for other light sources to be used. The camera global positioning device of each of the plurality of external cameras 51 tracks the location of the plurality of external cameras 51 in the event one of the plurality of internal cameras is lost or stolen.

The digital video recorder 53 allows the video streams from both the plurality of internal cameras 25 and the plurality of external cameras 51 to be digitally stored. The digital video recorder 53 is communicably coupled to the central control unit 1 either through a wireless or wired connection. The video streams from the plurality of internal cameras 25 and the plurality of external cameras 51 are first directed to the central control unit 1, wherein the central control unit 1 then routes the video streams to the digital video recorder 53. The digital video recorder 53 then stores the video streams, wherein the central control unit 1 can retrieve the video streams from the digital video recorder 53 at a later time. In addition to routing the video streams to the digital video recorder 53, the central control unit 1 can send the video streams to the personal security unit 3, the personal computing device 71, and the third party surveillance server 9.

In reference to FIG. 10, the plurality of sensors 52 is used in conjunction with the plurality of internal cameras 25 and the plurality of external cameras 51 to monitor the vehicle 8. As such, each of the plurality of sensors 52 is integrated into the vehicle 8, wherein the plurality of sensors 52 is communicably coupled to the central control unit 1, either via a wireless or wired connection. In the preferred embodiment of the present invention, each of the plurality of sensors 52 is electrically connected to the battery of the vehicle 8 and the backup battery 6, as depicted in FIG. 9, however, it is also possible for the plurality of sensors 52 to be powered by a separate power source. The plurality of sensors 52 can be used to monitor both the vehicle 8 and the environment around the vehicle 8. For example, the plurality of sensors 52 may include diagnostic sensors to monitor the performance of the vehicle 8 and when maintenance needs to be performed, in addition to proximity sensors to detect the approach of objects around the vehicle 8.

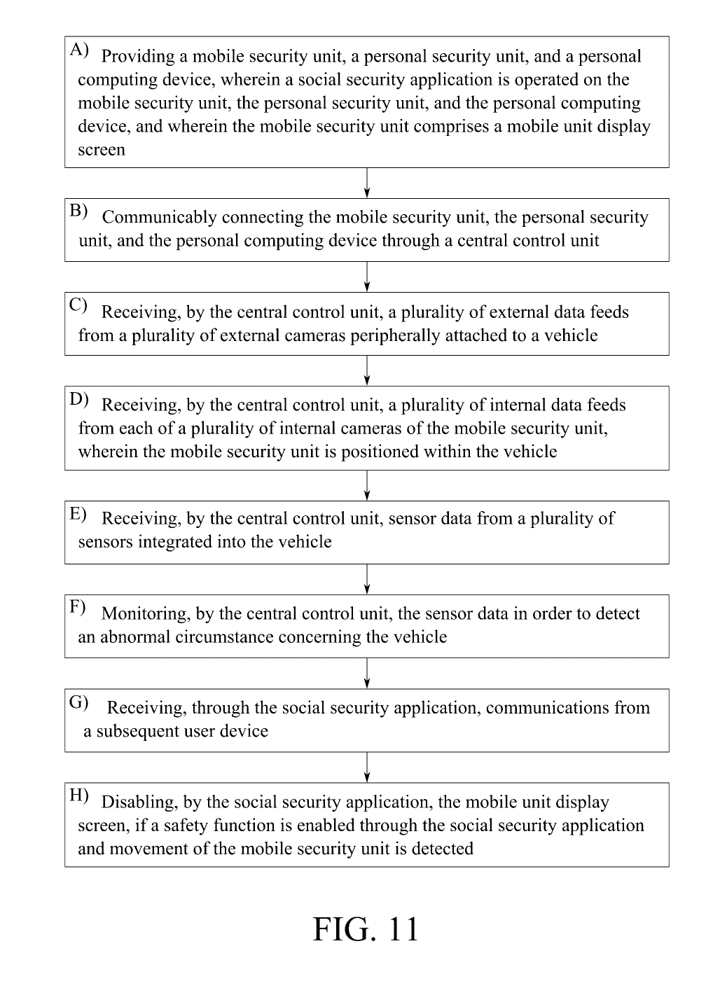

Each of the plurality of sensors 52 continuously gathers information in relation to the vehicle 8, wherein the central control unit 1 receives sensor data from the plurality of sensors 52. The sensor data is electronic signals that are sent by the plurality of sensors 52 in response to stimuli detected by the plurality of sensors 52. In reference to FIG. 11, the central control unit 1 monitors and analyzes the sensor data in order to detect an abnormal circumstance concerning the vehicle 8. The abnormal circumstance is detected by a change in the sensor data, wherein the sensor data is not comparable to parameters defining a normative state. When the abnormal circumstance is detected, the central control unit 1 can then alert the user that the vehicle 8 is damaged, maintenance is required, suspicious activity or vandalism is occurring, etc. In some embodiments of the present invention, the central control unit 1 may further comprise an on-board diagnostics port, wherein an on-board diagnostics device can be electronically connected to the central control unit 1. When connected to the central control unit 1, the on-board diagnostics device can use the sensor data to run diagnostics tests on the vehicle 8.

The on-board diagnostics device can also be used to check on the components of the present invention through the central control unit 1, in addition to diagnostic tests on the vehicle 8. For example, the on-board diagnostics device could be used to determine whether or not each of the plurality of external cameras 51 and each of the plurality of sensors 52 is functioning properly. The status of the plurality of external cameras 51 and the plurality of sensors 52 can be checked by taking data readings of the plurality of external cameras 51 and the plurality of sensors 52 and comparing the data readings to expected results. If the data readings and the expected results do not match, then the on-board diagnostic device reports the error. Tests can also be run to check the charge of the backup battery 6, or to ensure the central control unit 1 and the digital video recorder 53 are functioning properly.

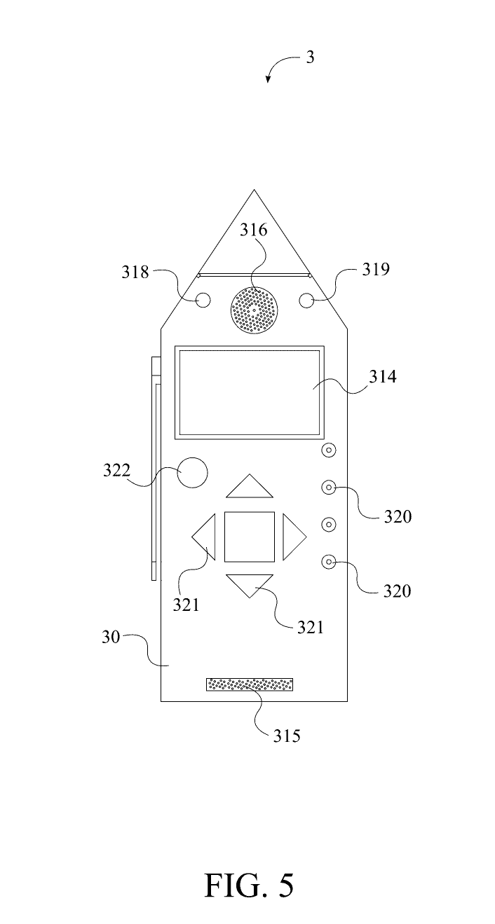

In reference to FIG. 5, the personal security unit 3 is a portable device that can be carried by the user and is used to remotely connect to the mobile security unit 2 and other users via the social security application. The personal security unit 3 comprises a personal unit housing 30, a personal unit electronic circuit 31, and a personal unit power supply 33. The personal unit housing 30 is a rigid structure that supports the other components of the personal security unit 3 and can be attached to the body of the user. In the preferred embodiment of the present invention the personal unit housing 30 is ergonomically shaped to fit into the hand of the user, and to be unobtrusively attached to the clothing of the user.

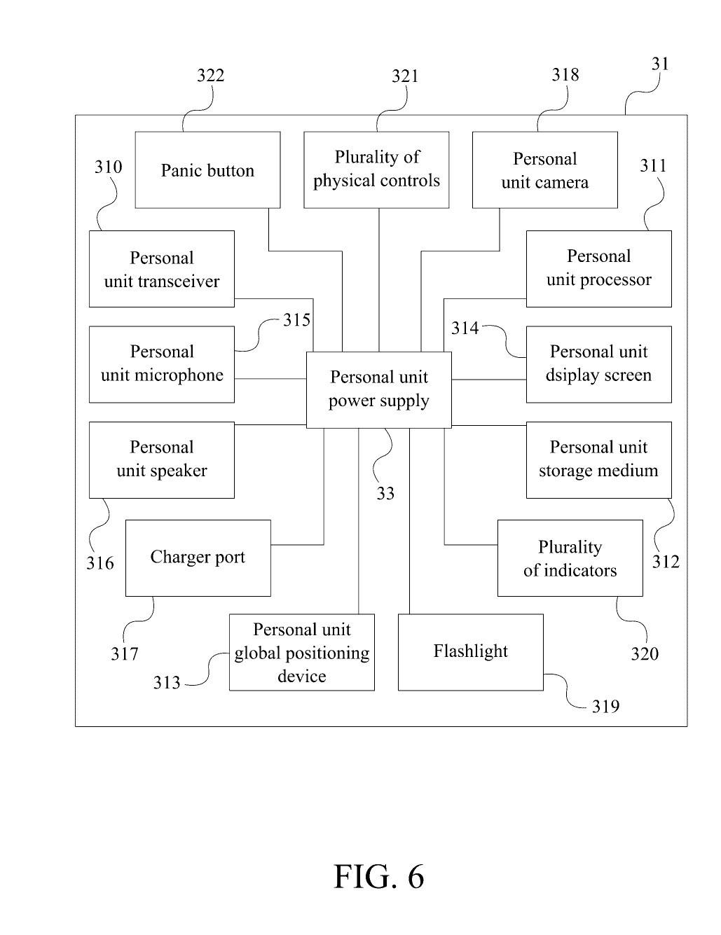

The personal unit electronic circuit 31 and personal unit power supply 33 are integrated into the personal unit housing 30. In reference to FIG. 6, the personal unit electronic circuit 31 comprises the electronic components required to perform the desired functions of the social security application; more specifically, the personal unit electronic circuit 31 comprises a personal unit transceiver 310, a personal unit processor 311, a personal unit storage medium 312, a personal unit global positioning device 313, a personal unit display screen 314, a personal unit microphone 315, a personal unit speaker 316, a charger port 317, a personal unit camera 318, a flashlight 319, a plurality of indicators 320, an at least one personal unit motion sensor, and a plurality of physical controls 321. The personal unit transceiver 310 allows the personal security unit 3 to communicate with the central control unit 1, and other devices such as the personal security unit 3, via commonly available wireless standards. The social security application is stored on the personal unit storage medium 312, while the personal unit processor 311 processes received signals in order to execute the functions of the social security application.

The personal unit global positioning device 313 tracks the current location of the personal security unit 3, wherein location data for the personal security unit 3 can be shared with the third party surveillance server 9 and other users of the social security application. In the preferred embodiment of the present invention, the personal unit global positioning device 313 is a GPS receiver that utilizes GPS satellites to retrieve the location data for the personal security unit 3. Other embodiments of the present invention are designed with alternative positioning systems which can be used to locate the personal security unit 3. The personal unit global positioning device 313 is electronically connected with the personal unit processor 311, wherein the location data is received through the personal unit global positioning device 313 and subsequently processed by the personal unit processor 311.

In reference to FIG. 5, the personal unit display screen 314 is positioned through the personal unit housing 30 such that the personal unit display screen 314 is visible to the user. The personal unit display screen 314 provides a means for presenting the GUI of the social security application. The GUI allows the user to interact with the social security application and view information such as other user profiles, message feeds, and video streams sent from other users, in addition to video streams from the plurality of external cameras 51 and the plurality of internal cameras 25. In some embodiments of the present invention, the personal unit display screen 314 is a touchscreen, wherein the user can navigate through the GUI using touch inputs.

In further reference to FIG. 5, the plurality of physical controls 321 is integrated into the personal unit housing 30 and allows the user to interact with the social security application. In the preferred embodiment of the present invention, the plurality of physical controls 321 includes a power button to turn the personal security unit 3 off and on, a call button to initiate a call with the personal computing device 71 or the mobile security unit 2, a record button to record video streams from the personal unit camera 318, a panic button 322 to alert the security surveillance agency or emergency personnel, and a location button to show the current location of the personal security unit 3. It is possible for any other number of controls to be provided in other embodiments of the present invention, such as controls for navigating through the GUI or typing in text. If the personal unit display screen 314 is a touchscreen, then some or all of the plurality of physical controls 321 may be provided as icons through the GUI.

In yet further reference to FIG. 5, the personal unit microphone 315 and the personal unit speaker 316 provide an audio input and an audio output, respectively, for the personal security unit 3. The personal unit microphone 315 and the personal unit speaker 316 allow the user to verbally communicate with the social security application and other users. By verbally inputting voice commands through the personal unit microphone 315, the user can control functions of the social security application and navigate the GUI on the personal security unit 3. Voice commands can include, but are not limited to, a command to send a text message, command to read a text message, command to connect to another user, and command to search a webpage. Additionally, in some embodiments, when the personal security unit 3 is in a low power or sleep mode, the personal unit microphone 315 can be used to prompt the personal security unit 3 to enter a higher power state upon the detection of screams, a cry for help, etc. The personal unit speaker 316 allows the social security application to verbally communicate back to the user to confirm the execution of a command or relay information to the user. When connected to a second user through the social security application, the personal unit microphone 315 allows the user to speak to the second user, while the personal unit speaker 316 allows the user to listen to the second user.

Further referencing FIG. 5, the personal unit camera 318 enables the user to capture photos and video of the immediate surroundings using the personal security unit 3. As such, the personal unit camera 318 is integrated into the personal unit housing 30, such that the personal unit camera 318 is able to view the environment around the personal security unit 3. In the preferred embodiment of the present invention, the personal unit camera 318 is positioned through a front surface of the personal unit housing 30, such that the user can view the personal unit display screen 314 as the personal unit camera 318 records the user. However, it is possible for the personal unit camera 318 to be integrated into any other surface of the personal unit housing 30. It is also possible for a plurality of personal unit cameras to be utilized in other embodiments of the present invention, wherein each of the plurality of personal unit cameras can be positioned about a different surface of the personal unit housing 30. Additionally, in some embodiments, when the personal security unit 3 is in a low power or sleep mode, the personal unit camera 318 can be used to prompt the personal security unit 3 to enter a higher power state upon the detection of a dangerous situation such as a fight.

In further reference to FIG. 5, the flashlight 319 and the plurality of indicators 320 are both light sources that are integrated into the personal unit housing 30. The flashlight 319 is a high luminance light that is used for illuminating an area on which the flashlight 319 is focused. Meanwhile, the plurality of indicators 320 provides a visual indicia of certain states of the personal security unit 3 and the mobile security unit 2. For example, the plurality of indicators 320 can indicate a power state of the personal computing device 71, indicate whether or not the personal security unit 3 is connected to the mobile security unit 2, or indicate irregular activity around the vehicle 8 that is recorded by the mobile security unit 2 or the plurality of external cameras 51. Preferably, each of the plurality of indicators 320 is a light emitting diode (LED), however, it is possible for any other type of light source to be utilized.

The at least one personal unit motion sensor provides a means for detecting movement around the personal security unit 3. The at least one personal unit motion sensor is positioned through a surface of the personal unit housing 30 and is used to detect the motion of objects around the personal security unit 3. When the personal security unit 3 is in a low power or sleep mode, detection of motion by the at least one personal unit motion sensor prompts the personal security unit 3 to enter a higher power state. In the preferred embodiment of the present invention, the at least one personal unit motion sensor is specifically a single motion sensor, wherein the single motion sensor is positioned on the front of the personal unit housing 30.

The personal unit power supply 33 is positioned within the personal unit housing 30 and provides electrical current to the personal unit electronic circuit 31, the personal unit camera 318, and the flashlight 319. In the preferred embodiment of the present invention, the personal unit power supply 33 is a rechargeable battery that supplies current to the personal unit electronic circuit 31. The personal unit power supply 33 is positioned within a cavity of the personal unit housing 30, wherein the personal unit housing 30 comprises an access panel that is removable in order to allow access to the cavity. The personal unit power supply 33 can be recharged via the charger port 317 that is positioned through the personal unit housing 30. Preferably the charger port 317 is a USB port, however, it is possible for any type of port to be used. When the personal security unit 3 is attached to the docking station 24 of the mobile security unit 2, the charger port 317 engages the personal unit charger, wherein current is supplied to the personal unit power supply 33 through the personal unit charger.

In another embodiment, the personal security unit is wirelessly charged by the mobile security unit. The personal security device 3 is positioned within the docking station 24 of the mobile security unit 2, wherein the personal security device 3 is secured in place using a fastening mechanism. A wireless charging mechanism, such as an induction coil, is positioned within the mobile unit housing 20, adjacent to the docking station 24. Power is supplied to the wireless charging mechanism, which in turn generates an electromagnetic field that is used to charge the personal security unit 3. A subsequent wireless charging mechanism, such as a subsequent induction coil, is positioned within the personal unit housing 30, wherein the subsequent wireless charging mechanism takes power from the electromagnetic field generated by the wireless charging mechanism. The subsequent wireless charging mechanism then converts the electromagnetic field into electric current to charge the personal security unit 3.

The wireless earpiece 41 is a wireless component that is capable of connecting to the mobile security unit 2 and the personal security unit 3. In the preferred embodiment of the present invention, the wireless earpiece 41 is communicably connected to the mobile security unit 2 and the personal security unit 3 through the central control unit 1 as depicted in FIG. 7, however, it is also possible for the wireless earpiece 41 to be directly connected to the mobile security unit 2 and the personal security unit 3. In this way, the wireless earpiece 41 enables the user to establish two-way voice communication with another user and/or the social security application. As such, the wireless earpiece 41 includes a headset microphone and a headset speaker. In one embodiment of the wireless earpiece 41, the headset microphone is extended away from the body of the wireless earpiece 41, enabling the user to modify the position of the headset microphone relative to the user's mouth. In the preferred embodiment of the present invention, the headset speaker retains the wireless earpiece 41 in a desired position on the user's ear.

The personal health security monitor 42 is a device that is utilized to monitor both the vitals of the user and the location of the user. In the preferred embodiment of the present invention, the personal health security monitor 42 is a wristband that is worn by the user, however, the personal health security monitor 42 can be any other device worn by the user, such as a patch that is adhered to the skin of the user. The personal health security monitor 42 measures the vitals of the user, such as heartbeat and body temperature, and can be used to notify the security surveillance agency in the event that unnatural vitals are detected. The personal health security device can then send the location data of the user to the third party surveillance server 9, wherein agents of the security surveillance agency, or other emergency personnel, can be dispatched to assist the user.

In the preferred embodiment of the present invention the social security application is the software that enables the present invention to function as a personal surveillance system, social network, and emergency response system. The social security application comprises a profile engine, a communications engine, a user interface engine, and a control engine. The term ‘engine’ is used herein to describe collections of programs that have been grouped according to function. Similarly, the term ‘suite’ is used to denote smaller groups of programs within an engine. The profile engine enables the user to search for and connect with other users of the social security application. It is an aim of the present invention to provide a profile engine that enables the user to share information, such as videos and photos and messages or communications, with other users of the social security application.

The communications engine is tasked with coordinating video streams, text messages, and voice calls between the user and the other users of the social security application. Additionally, the communications engine governs the transmission of video data to the digital video recorder 53 and the third party surveillance server 9. Furthermore, the communications engine governs the device connections between the central control unit 1 and the mobile security unit 2, the personal security unit 3, the personal computing device 71, the wireless earpiece 41, and the personal health security monitor 42. The communications engine ensures that each command is relayed to the appropriate device to perform the corresponding action.

The user interface engine is tasked with formatting the information that is displayed via the GUI. The user interface engine comprises a display suite and input suite. The display suit is tasked with generating the visual layout of data presented through the GUI on the mobile security unit 2, the personal security unit 3, and the personal computing device 71. The input suite captures user inputs provided through the plurality of physical inputs 220, the mobile unit display screen 214, the plurality of physical buttons, the personal unit display screen 314, and the inputs of the personal computing device 71 on the mobile security unit 2, the personal security unit 3, or the personal computing device 71 and translates the user inputs into instructions for the social security application to execute.

In the preferred embodiment of the present invention the control engine is tasked with dictating the various routines required to make the physical components of the present invention work in concert. In one embodiment, the social security application generates automatic alerts and notifications when certain conditions are detected by the plurality of external cameras 51, the plurality of internal cameras 25, or the plurality of sensors 52. Upon detecting certain conditions, the social security application can automatically activate or deactivate vehicle 8 systems, send emergency alerts, contact friends and family, or perform other functions depending on the conditions detected by the plurality of external cameras 51, the plurality of internal cameras 25, and the plurality of sensors 52.

The social security application connects all of the devices together, providing the user with a robust system that can be utilized to monitor the user's vehicle 8 and communicate with other users. In reference to FIG. 11, the social security application is operated on the mobile security unit 2, the personal security unit 3, the personal computing device 71, and the central control unit 1. In the preferred embodiment of the present invention, the mobile security unit 2, the personal security unit 3, and the personal computing device 71 are communicably connected through the central control unit 1 as depicted in FIG. 7, however, in other embodiments the devices may be directly connected to each other.

In reference to FIG. 11, for monitoring the vehicle 8, the central control unit 1 receives a plurality of external data feeds from the plurality of external cameras 51 and a plurality of internal data feeds from the plurality of internal cameras 25. Both the plurality of external data feeds and the plurality of internal data feeds can include both video streams and audio streams. Once received by the central control unit 1, the plurality of external data feeds and the plurality of internal data feeds can be sent to and viewed on/heard through the mobile security unit 2, the personal security unit 3, and the personal computing device 71. The plurality of external data feeds and the plurality of internal data feeds are displayed through the social security application, wherein each of the plurality of external data feeds and each of the plurality of internal data feeds are displayed together on screen.

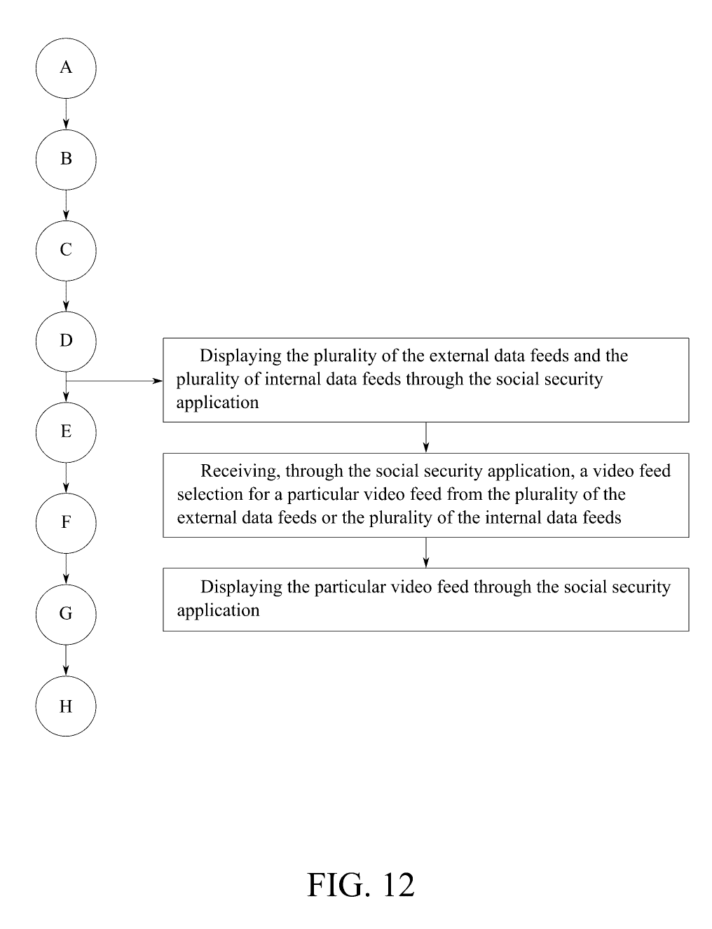

In reference to FIG. 12, through the social security application, the user can select a particular video from either the plurality of external data feeds or the plurality of internal data feeds to view alone. A video feed selection for the particular video is received through the social security application, wherein the particular video is then displayed through the social security application, replacing the display of the plurality of external data feeds and the plurality of internal data feeds. The video feed selection is input through the social security application using the plurality of physical inputs 220, the mobile unit display screen 214, the plurality of physical controls 321, the personal unit display screen 314, or the interface of the personal computing device 71.

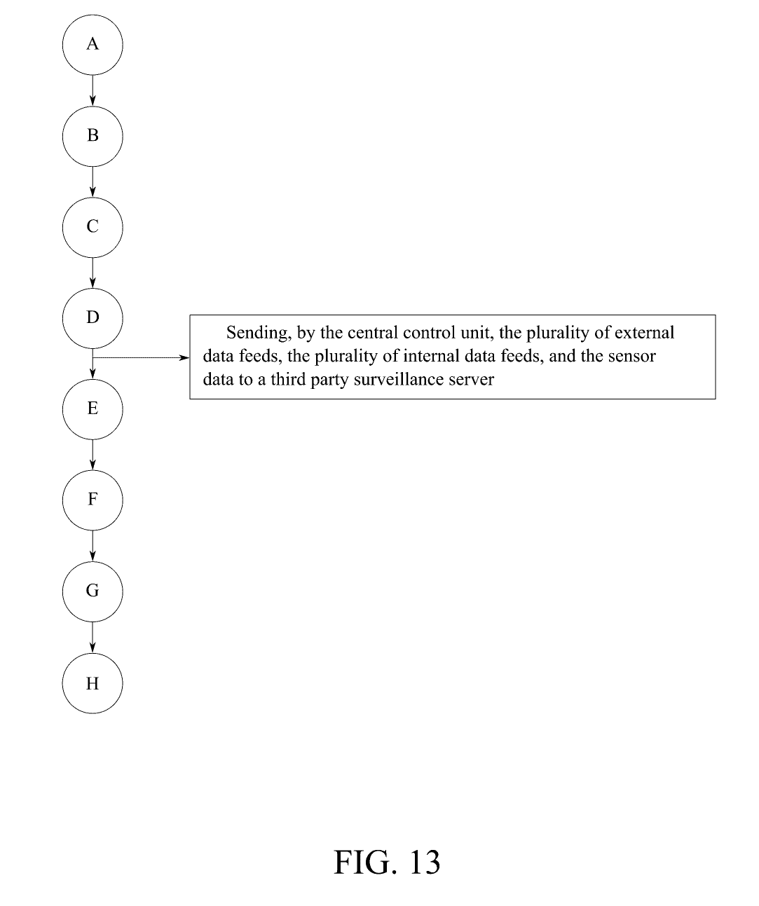

In reference to FIG. 13, the central control unit 1 can also send the plurality of external data feeds and the plurality of internal data feeds to the third party surveillance server 9, along with the sensor data collected from the plurality of sensors 52. This allows the security surveillance agency to constantly monitor the user and the vehicle 8, providing around the clock surveillance of the vehicle 8, even when the user is not able to monitor the user and the vehicle 8 personally. If the security surveillance agency detects any questionable activity within the vicinity of the vehicle 8, then the security surveillance agency can notify the user through the social security application on the mobile security unit, the personal security unit 3, or the personal computing device 71.

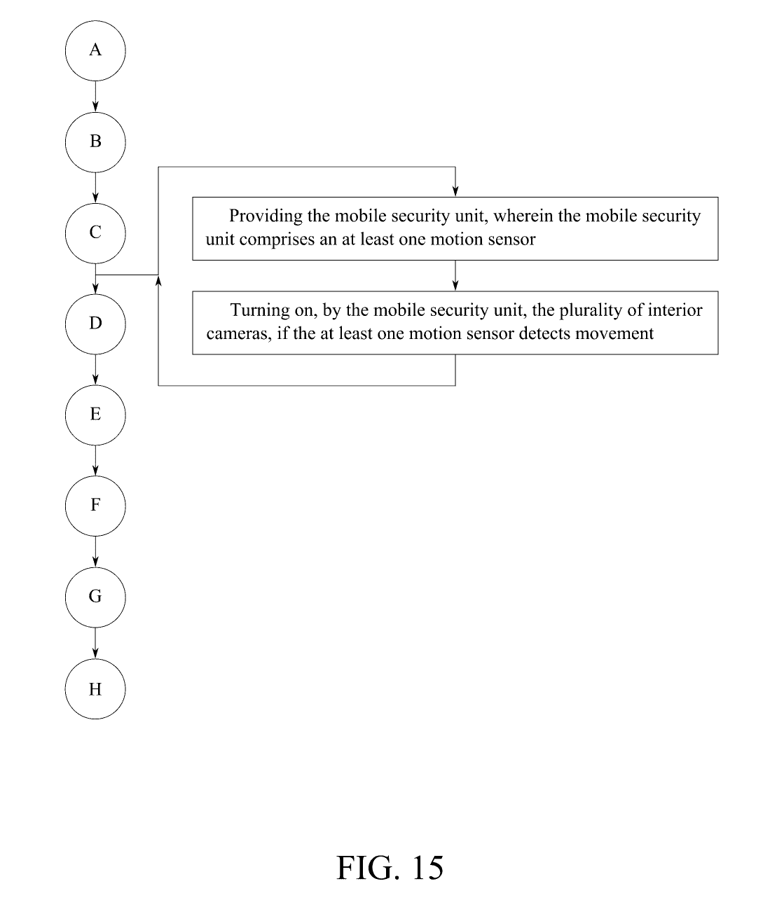

The user can also remotely turn the mobile security unit 2 and the plurality of external cameras 51 off and on through the social security application. In certain situations, the user may not want constant surveillance, but would rather check in on the vehicle 8 every now and then. In such a case, the user can utilize the social security application on the personal security unit 3 or the personal computing device 71 to turn the mobile security unit 2 and the plurality of external cameras 51 off and on. In reference to FIG. 15, the at least one motion sensor 218 of the mobile security unit 2 can also be utilized to turn the plurality of internal cameras 25 and the plurality of external cameras 51 on when the user is away from the vehicle 8. In this way, the mobile security unit 2 can still provide surveillance when needed, while conserving battery power. The plurality of sensors 52 can also be utilized to toggle the plurality of internal cameras 25 and the plurality of external cameras 51 on and off.

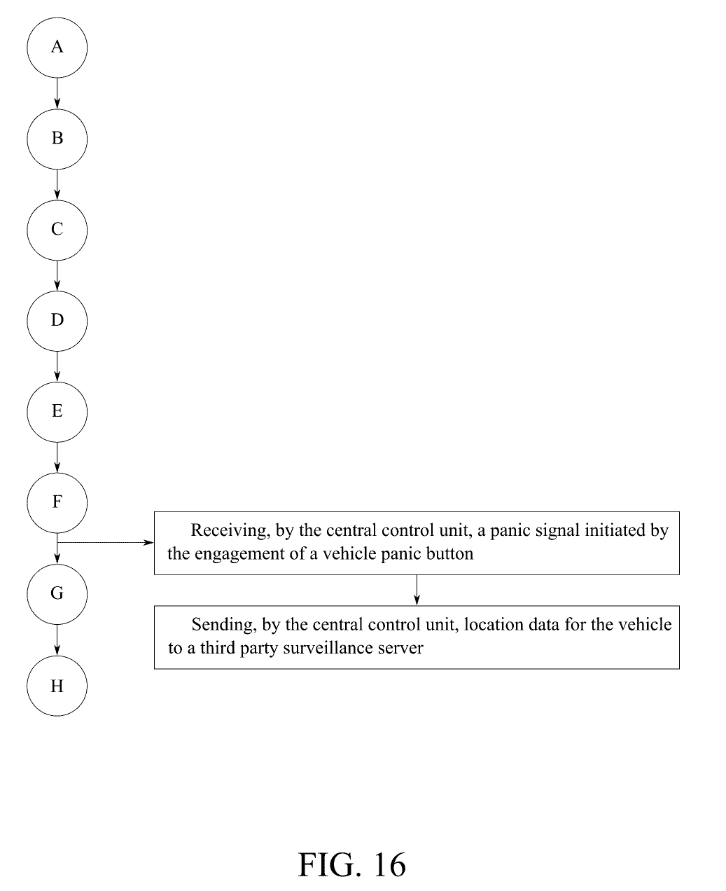

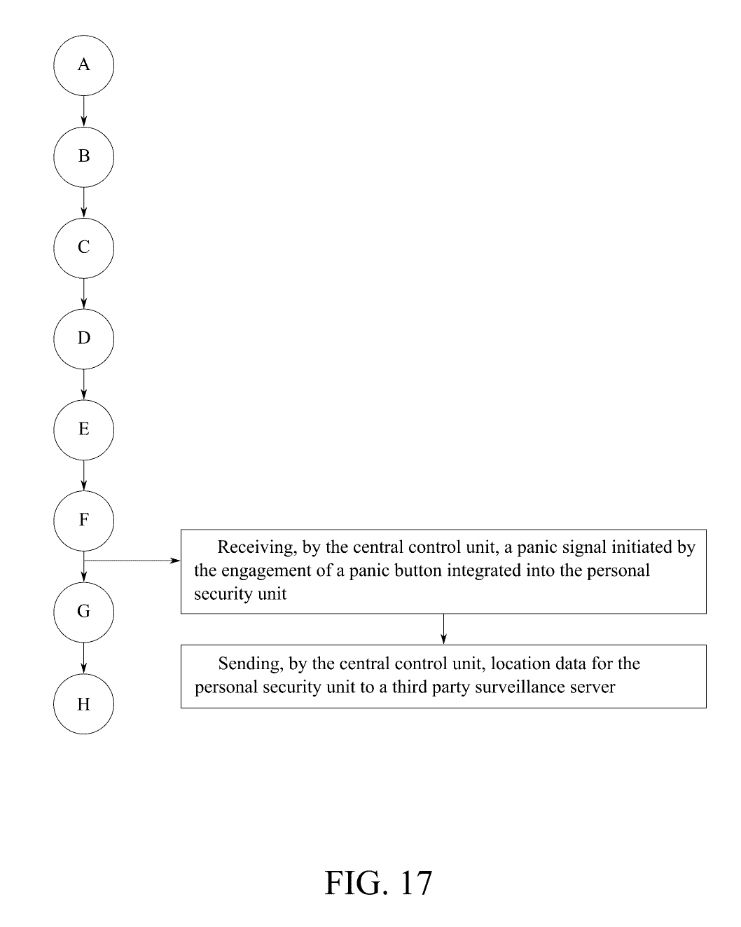

In reference to FIG. 16-17, if the user notices suspicious activity around the vehicle 8, or if the user is in a threatening or otherwise unsafe situation, then the user can utilize either a vehicle panic button 80 or a panic button 322 integrated into the personal security unit 3. When the user engages the vehicle panic button 80, a panic signal is received by the central control unit 1, wherein the central control unit 1 sends location data for the vehicle 8 to the third party surveillance server 9. Similarly, when the user engages the panic button 322 of the personal security unit 3, a panic signal is received by the central control unit 1, wherein the central control unit 1 sends the location data for the personal security unit 3 to the third party surveillance server 9. Alternatively, the location data for the personal security unit 3 can be sent directly from the personal security unit 3 to the third party surveillance server 9, which is beneficial in the event that the personal security unit 3 is not in the vicinity of the vehicle 8. Upon receiving the location data for either the vehicle 8 or the personal security unit 3, the security surveillance agency can take the appropriate actions to ensure the safety of the user.

The vehicle panic button 80 may be implemented in a number of ways. In one embodiment of the present invention, the vehicle panic button 80 is integrated into a key fob 82, wherein the vehicle panic button 80 is wirelessly connected to the central control unit 1. In another embodiment of the present invention, the vehicle panic button 80 is integrated into a steering wheel 81 of the vehicle 8. When integrated into the steering wheel 81, the vehicle panic button 80 may be either wirelessly connected to the central control unit 1 or wired directly to central control unit 1. In the preferred embodiment of the present invention, two vehicle panic buttons are utilized; one in the steering wheel 81 and one in the key fob 82.

A panic button 322 may also be integrated into the mobile security unit 2. When the user engages the panic button 322 of the mobile security unit 2, a panic signal is received by the central control unit 1, wherein the central control unit 1 sends the location data for the mobile security unit 2 to the third party surveillance server 9. Alternatively, the location data for the mobile security unit 2 can be sent directly from the mobile security unit 2 to the third party surveillance server 9, which is beneficial in the event that the mobile security unit 2 is not in the vicinity of the vehicle 8. Upon receiving the location data for the mobile security unit 2, the security surveillance agency can take the appropriate actions to ensure the safety of the user.

Furthermore, the social security application may provide a digital panic button that is accessible on the personal computing device 71, or any other device on which the social security application is operated. When the user engages the digital panic button through the social security application on the personal computing device 71, a panic signal is received by the central control unit 1, wherein the central control unit 1 sends location data for the personal computing device 71 to the third party surveillance server 9. Alternatively, the location data for the personal computing device 71 can be sent directly from the personal computing device 71 to the third party surveillance server 9, which is beneficial in the event that the personal computing device 71 is not in the vicinity of the vehicle 8. Upon receiving the location data for the personal computing device 71, the security surveillance agency can take the appropriate actions to ensure the safety of the user.

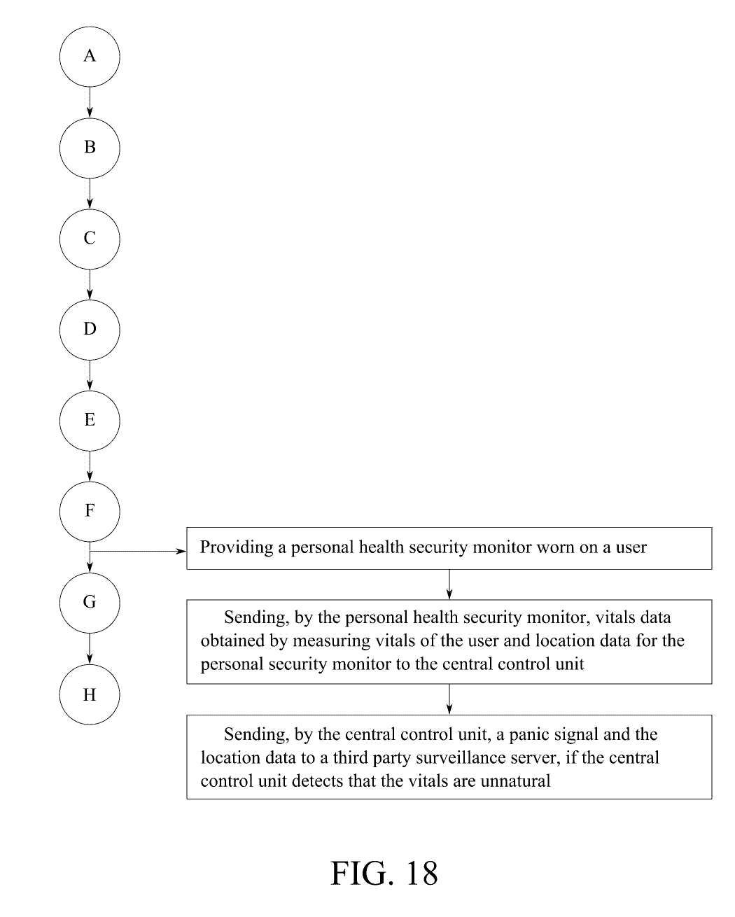

In reference to FIG. 18, a panic signal can also be initiated from the vitals data obtained by the personal health security monitor 42. When the user is wearing the personal health security monitor 42, the personal health security monitor 42 constantly, or intermittently, measures the vitals of the user in order to collect the vitals data. The personal health security monitor 42 then sends the vitals data along with location data for the user to the central control unit 1. The central control unit 1 then analyzes the vitals data, checking for any abnormalities. If the central control unit 1 detects that the vitals are unnatural through the analysis of the vitals data, then the central control unit 1 sends a panic signal along with the location data for the user to the third party surveillance server 9. The security surveillance agency can then send the appropriate emergency personnel, as determined by the analysis of the vitals data, to the location of the user. Alternatively, the vitals data can be analyzed by the personal health security monitor 42, wherein the personal health security monitor 42 sends the panic signal and the location data for the user directly to the third party surveillance server 9.

A panic button 322 can also be integrated into the personal health security monitor 42. The panic button 322 of the personal health security monitor 42 allows the user to manually activate the panic signal, as opposed to initiating the panic signal when the personal health security monitor 42 detects abnormal vitals. When the user engages the panic button 322 of the personal health security monitor 42, the panic signal is received by the central control unit 1, wherein the central control unit 1 sends the location data for the personal health security monitor 42 to the third party surveillance server 9. Alternatively, the location data for the personal health security monitor 42 can be sent directly from the personal health security monitor 42 to the third party surveillance server 9, which is beneficial in the event that the personal health security monitor 42 is not in the vicinity of the vehicle 8. Upon receiving the location data for personal health security monitor 42, the security surveillance agency can take the appropriate actions to ensure the safety of the user.

In addition to providing a plethora of security features, the social security application provides a social network through which the user can communicate and share information with the other users of the social security application. The user can create a list of contacts, wherein the user can view information shared by the other users from the list of contacts. Each of the other users can be added to the list of contacts individually, or a group of contacts can be added to the list of contacts at the same time. For example, the group of contacts can be imported from the phone contacts on the personal computing device 71, or the contact list from another social networking site.

The social security application also provides two search engines; a first search engine for finding contacts and a second search engine for searching the internet. The first search engine can be utilized to find search for existing contacts within the list of contacts, or the first search engine can be used to find new contacts that the user has not yet added to the list of contacts. The new contacts and the existing contacts can be searched for by entering a name, email address, or other personal information. Meanwhile, the second search engine can be used to search for content from third party websites. Content found through the second search engine can be imported through the social security application and shared with the other users. Content can be shared by posting the content into a public or private media stream, or by directly sharing the content with the desired users.

Once the user has created the list of contacts, the user can share videos, photos, status updates, live video streams, etc. to each of the other users on the list of contacts. Additionally, the user can receive communications from a subsequent user device 72 of one of the other users. The communications can be in the form of a standard voice call, a video call, a text message, etc. The subsequent user device 72 is communicably coupled to either the mobile security unit 2, the personal security unit 3, or the personal computing device 71 through the central control unit 1. In reference to FIG. 11, the social security application receives communications from the subsequent user device 72 and directs them to the appropriate device.

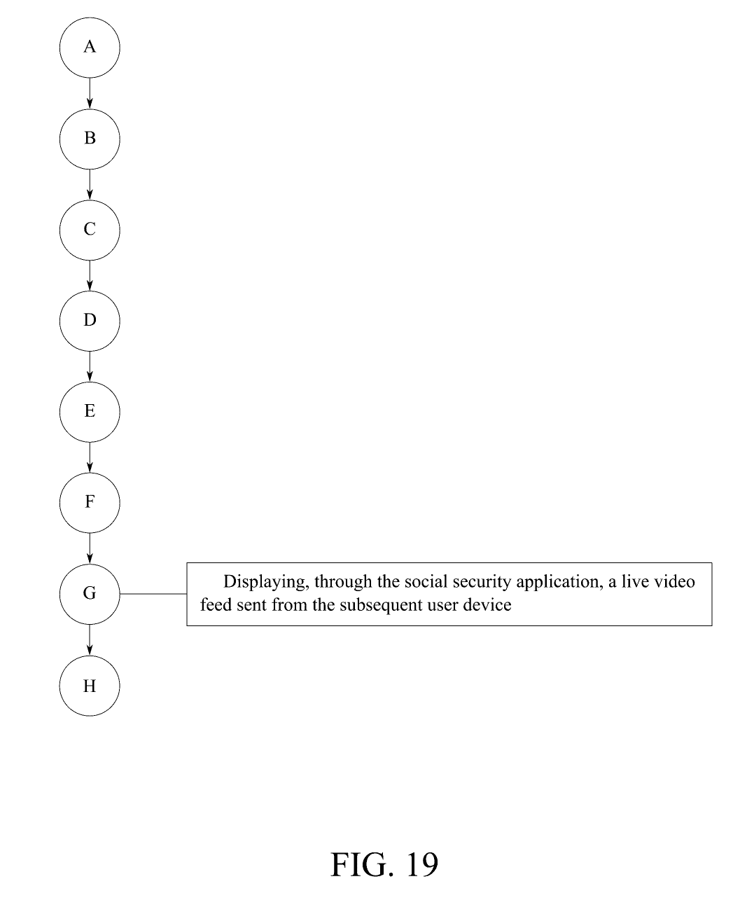

The user can request to view live video streams from the other users by sending a live views request. The live views request is sent to the subsequent user device 72 of the desired user, wherein the desired user can choose to accept or deny the request. If the live views request is accepted by the desired user, then the user is able to view a live video feed from the subsequent user device 72, as depicted by FIG. 19. As the social security application can be utilized standalone on devices without a camera, it is possible that certain users are not able to share live video streams. In order to differentiate users with video streaming capabilities from users without said capabilities, the social security application utilizes a colored icon to visibly indicate the users with said capabilities. In the preferred embodiment of the present invention, the colored icon is green to indicate the users with the video streaming capabilities, while the colored icon is red to indicate the user without the video streaming capabilities.

When the user receives a live views request from one of the other users on the list of contacts, an indicator is utilized to notify the user of the live views request. The indicator can be an icon displayed through the GUI, a physical blinking light, a vibration, an audio prompt, etc. The live views request can be sent to view one of the external video feeds, one of the internal video feeds, a video feed from the personal unit camera 318, or a video feed from the personal computing device 71. Furthermore, the live views request can be for one or more video feeds. The other user is only able to view the selected video feeds if the user to whom the live views request was sent, gives permission to the other user through the social security application.

The live views request can be used to perform face to face video chat, wherein a video stream for both the user and the desired user is displayed through the GUI. The video stream for the desired user with whom the user is communicating is displayed in a video box. Meanwhile, the video stream for the user is displayed as a smaller box within the video box. If a group chat is being performed, then a plurality of video streams may be displayed within the video box as a plurality of smaller boxes. By selecting one of the smaller boxes, the user can replace the video stream of the desired user within the video box with the video stream of another user. In addition to face to face communications, the present invention allows for standard calls through the social security application.

In reference to FIG. 11, the social security application also provides a safety function for restricting the use of the mobile unit display screen 214 while operating the vehicle 8. When the safety function is enabled, if the social security application detects movement of the vehicle 8, then the social security application disables the mobile unit display screen 214. The safety function only affects the devices of the user, the other user can still view interior or exterior camera feeds on the subsequent user device 72, unless the safety feature is also turned on, on the subsequent user device 72 and the other user is also driving. When the mobile unit display screen 214 is disabled, the user cannot perform face to face communications, view video streams through the mobile security unit 2, etc. Movement of the vehicle 8 may be detected using the plurality of sensors 52, the accelerometer 217, the mobile unit global positioning device 213, or combination thereof. While the user cannot utilize the mobile unit display screen 214, the user can still speak to the other users using voice communications and interact with the social security unit using voice commands. The safety function can also be toggled on and off manually by the user through the GUI.

In the preferred embodiment of the present invention, the safety function is password protected. In order to toggle the safety function on and off, the user must first be authenticated by entering a password through the GUI. Upon receiving and successfully verifying the password, the social security application toggles the safety function to the desired state. The present invention is not limited to authenticating the user by employing a password; in other embodiments other methods of authentication may be used, including but not limited to token authentication, biometric authentication, or a combination thereof.

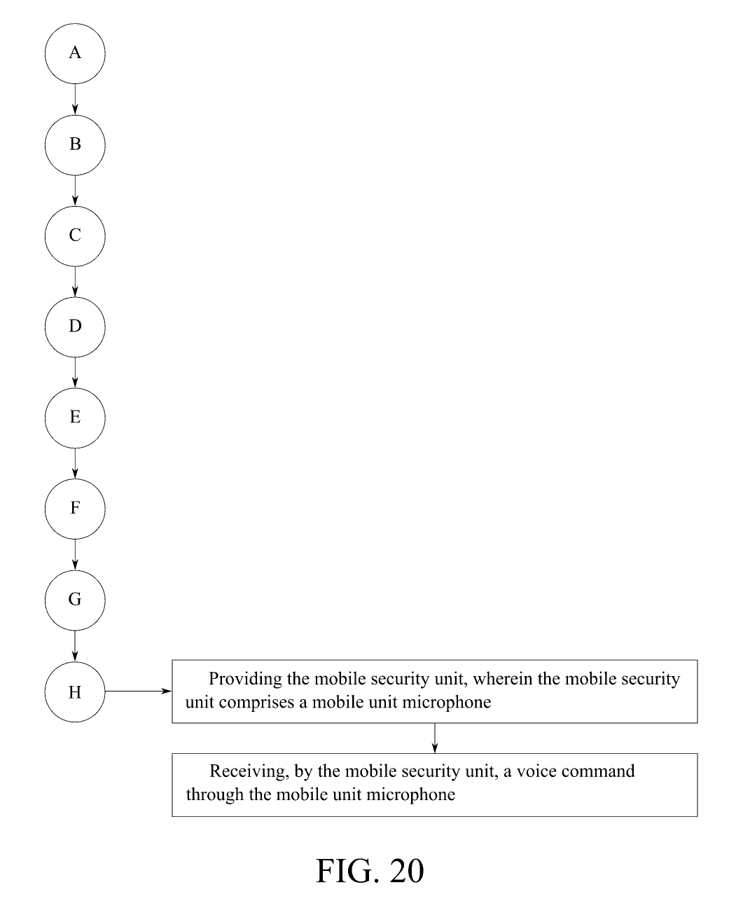

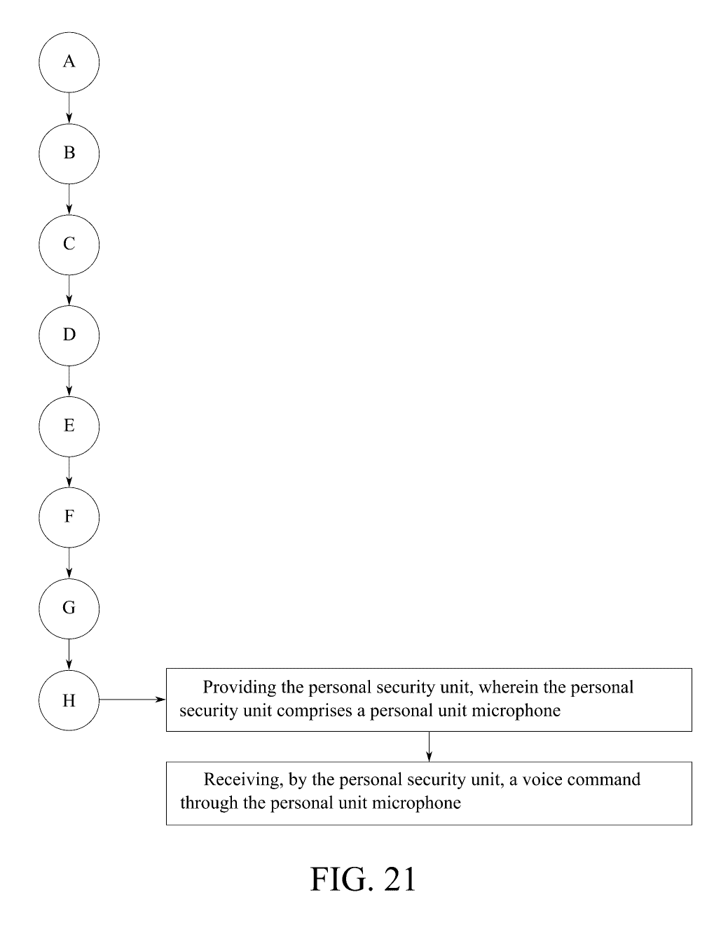

The user can utilize voice commands to start recording video, stop or pause video, send a text message, have a text message be read out loud, and access and other number of functions of the present invention. The user can issue a voice command through the mobile security unit 2, the personal security unit 3, the wireless earpiece 41, or the personal computing device 71 in order to control functions of the social security application. In reference to FIG. 20, when the voice command is dictated to the mobile security unit 2, the voice command is received by the mobile security unit 2 through the mobile unit microphone 215, wherein the corresponding action is carried out by the social security application. In reference to FIG. 21, if the voice command is dictated to the personal security unit 3, then the voice command is received by the personal security unit 3 through the personal unit microphone 315, wherein the corresponding action is carried out by the social security application.

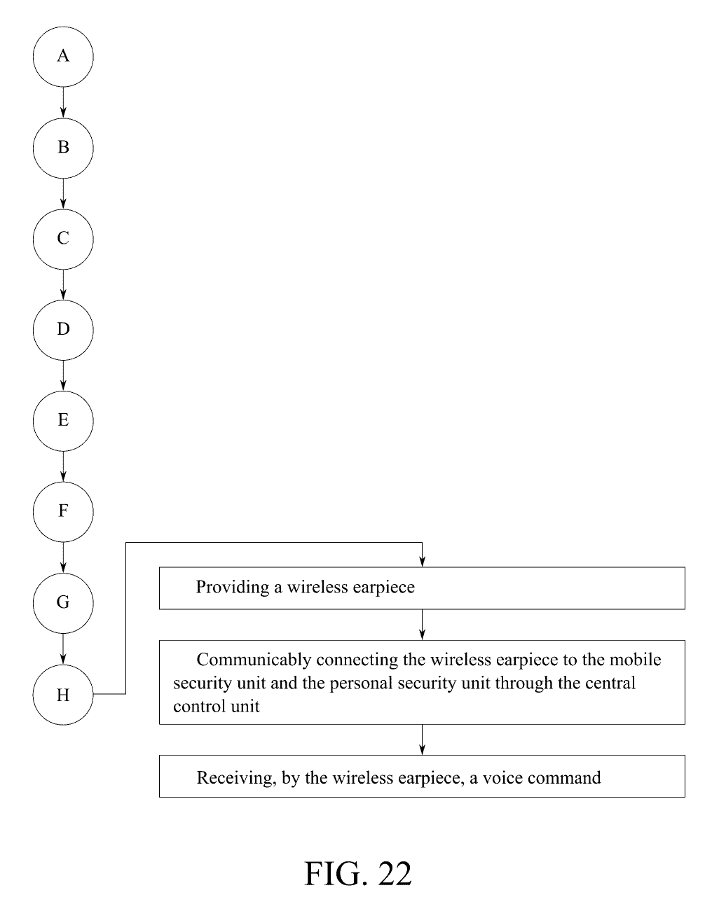

In reference to FIG. 22, when the voice command is dictated through the wireless earpiece 41, the wireless earpiece 41 receives the voice command and routes the voice command to the appropriate device. In the preferred embodiment of the present invention, the wireless earpiece 41 is communicably connected to the mobile security unit 2 and the personal security unit 3 through the central control unit 1. When the wireless earpiece 41 receives the voice command, the voice command is then relayed to the central control unit 1, wherein the central control unit 1 determines which device to route the voice command to. In other embodiments of the present invention, it is possible for the wireless earpiece 41 to be directly connected to the mobile security unit 2 or the personal security unit 3, wherein the voice command is directly relayed to either the mobile security unit 2 or the personal security unit 3.

While the security aspects and the social aspects of the social security application can be viewed independently of each other, the social security application also allows the user to utilize both the security aspects and the social aspects on one screen. In the preferred embodiment of the present invention, a main page of the social security application is split 30% towards the security aspects and 70% towards the social aspects. The plurality of external data feeds and the plurality of internal data feeds are displayed on one side of the main page, with the live video feed from the subsequent user device 72 being displayed above the plurality of external data feeds and the plurality of internal data feeds. On the other side of the main page is the first search engine, the second search engine, and a media stream of information shared from the other users.

The GUI of the social security application can also be split to only display the different video feeds. For example, the GUI can be split in half, wherein one half displays the plurality of external data feeds and the plurality of internal data feeds, while the other half displays the live video feed from the subsequent user device 72. If the user only wants to view the particular video feed from either the plurality of external data feeds or the plurality of internal data feeds, then the particular video feed is displayed on one half, while the live video feed of the subsequent user device 72 is displayed on the other half.

The social security application also provides a play center, wherein the user can view the plurality of external data feeds and the plurality of internal data feeds that are stored on the digital video recorder 53 The digital video recorder 53 can also be used to store the vitals data gathered from the personal health security monitor 42, the location data from mobile security unit 2 or the personal security unit 3, or voice messages received through the social security application; the vitals data, the location data, and the voice messages being accessible to the user via the play center. In order to access the play center, the user must enter a security password. Once the security password is authenticated by the social security application, the user is able to select the desired video feeds for viewing. Additionally, the play center provides the user with viewing functions such as play, pause, stop, rewind, fast forward, etc.

Although the invention has been explained in relation to its preferred embodiment, it is to be understood that many other possible modifications and variations can be made without departing from the spirit and scope of the invention as hereinafter claimed.

What is claimed is:

1. A method for operating a mobile security system across a social security network comprises the steps of:
providing a mobile security unit, a personal security unit, and a personal computing device, wherein a social security application is operated on the mobile security unit, the personal security unit, and the personal computing device, and wherein the mobile security unit comprises a mobile unit display screen;
communicably connecting the mobile security unit, the personal security unit, and the personal computing device through a central control unit;
receiving, by the central control unit, a plurality of external data feeds from a plurality of external cameras peripherally attached to a vehicle;
receiving, by the central control unit, a plurality of internal data feeds from each of a plurality of internal cameras of the mobile security unit, wherein the mobile security unit is positioned within the vehicle;
receiving, by the central control unit, sensor data from a plurality of sensors integrated into the vehicle;
monitoring, by the central control unit, the sensor data in order to detect an abnormal circumstance concerning the vehicle;
receiving, through the social security application, communications from a subsequent user device; and
disabling, by the social security application, the mobile unit display screen,
if a safety function is enabled through the social security application and movement of the mobile security unit is detected.

2. The method for operating a mobile security system across a social security network as claimed in claim 1 further comprises the steps of:
displaying the plurality of the external video feeds and the plurality of internal data feeds through the social security application.

3. The method for operating a mobile security system across a social security network as claimed in claim 1 further comprises the steps of:
receiving, through the social security application, a video feed selection for a particular video feed from the plurality of the external video feeds; and
displaying the particular video feed through the social security application.

4. The method for operating a mobile security system across a social security network as claimed in claim 1 further comprises the steps of:
receiving, through the social security application, a video feed selection for a particular video feed from the plurality of the internal video feeds; and
displaying the particular video feed through the social security application.

5. The method for operating a mobile security system across a social security network as claimed in claim 1 further comprises the steps of:
sending, by the central control unit, the plurality of external data feeds, the plurality of internal data feeds, and the sensor data to a third party surveillance server.

6. The method for operating a mobile security system across a social security network as claimed in claim 1, wherein the plurality of external cameras comprises an at least one rooftop camera being attached to a roof of the vehicle.

7. The method for operating a mobile security system across a social security network as claimed in claim 1, wherein the plurality of external cameras comprises an at least one front bumper camera being attached to a front bumper of the vehicle.

8. The method for operating a mobile security system across a social security network as claimed in claim 1, wherein the plurality of external cameras comprises an at least one rear bumper camera being attached to a rear bumper of the vehicle.

9. The method for operating a mobile security system across a social security network as claimed in claim 1 further comprises the steps of:
receiving, by the central control unit, a panic signal initiated by the engagement of a vehicle panic button; and
sending, by the central control unit, location data for the vehicle to a third party surveillance server.

10. The method for operating a mobile security system across a social security network as claimed in claim 9, wherein the panic button is integrated into a steering wheel of the vehicle.

11. The method for operating a mobile security system across a social security network as claimed in claim 9, wherein the panic button is wirelessly connected to the central control unit.

12. The method for operating a mobile security system across a social security network as claimed in claim 1 further comprises the steps of:
receiving, by the central control unit, a panic signal initiated by the engagement of a panic button integrated into the personal security unit; and
sending, by the central control unit, location data for the personal security unit to a third party surveillance server.

13. The method for operating a mobile security system across a social security network as claimed in claim 1, wherein a backup battery is electrically connected to the central control unit, the plurality of external cameras, the plurality of sensors, and the vehicle.

14. The method for operating a mobile security system across a social security network as claimed in claim 1 further comprises the steps of:
providing a personal health security monitor worn on a user;
sending, by the personal health security monitor, vitals data obtained by measuring vitals of the user and location data for the personal security monitor to the central control unit; and
sending, by the central control unit, a panic signal and the location data to a third party surveillance server,
if the central control unit detects that the vitals are unnatural.

15. The method for operating a mobile security system across a social security network as claimed in claim 1 further comprises the steps of:
providing a wireless earpiece;
communicably connecting the wireless earpiece to the mobile security unit and the personal security unit through the central control unit; and
receiving, by the wireless earpiece, a voice command.

16. The method for operating a mobile security system across a social security network as claimed in claim 1 further comprises the steps of:
providing the personal security unit, wherein the personal security unit comprises a personal unit microphone; and
receiving, by the personal security unit, a voice command through the personal unit microphone.

17. The method for operating a mobile security system across a social security network as claimed in claim 1 further comprises the steps of:
providing the mobile security unit, wherein the mobile security unit comprises a mobile unit microphone; and
receiving, by the mobile security unit, a voice command through the mobile unit microphone.

18. The method for operating a mobile security system across a social security network as claimed in claim 1 further comprises the steps of:
sending, by the central control unit, the plurality of external data feeds and the plurality of internal data feeds to a digital video recorder; and
storing, by the digital video recorder, the plurality of external data feeds and the plurality of internal data feeds.

19. The method for operating a mobile security system across a social security network as claimed in claim 1 further comprises the steps of:
providing the mobile security unit, wherein the mobile security unit comprises an at least one motion sensor; and
turning on, by the mobile security unit, the plurality of interior cameras,
if the at least one motion sensor detects movement.

20. The method for operating a mobile security system across a social security network as claimed in claim 1 further comprises the steps of:
displaying, through the social security application, a live video feed sent from the subsequent user device.
